(19) United States
(12) Patent Application Publication
(10) Pub. No.: US 2026/0065255 A1
(43) Pub. Date: Mar. 5, 2026

(54) INFORMATION PROCESSING SYSTEM, INFORMATION PROCESSING DEVICE AND METHOD, AND PROGRAM

(71) Applicants: Sony Group Corporation, Tokyo (JP); Sony Financial Group Inc., Tokyo (JP)

(72) Inventors: Shinichi ONODERA, Tokyo (JP); Daisuke MATSUZAWA, Tokyo (JP); Kaya KANAMORI, Kanagawa (JP)

(73) Assignees: Sony Group Corporation, Tokyo (JP); Sony Financial Group Inc., Tokyo (JP)

(21) Appl. No.: 19/104,728

(22) PCT Filed: Nov. 7, 2023
(86) PCT No.: PCT/JP2023/039966

§ 371 Date: Feb. 19, 2025

(30) Foreign Application Priority Data
Dec. 7, 2022 (JP) 2022-195317

(51) Int. Cl. G06Q 20/22; G06F 3/0482; G06Q 20/10; G06Q 20/32; G06Q 20/36; G06Q 20/38; G06Q 20/40

(52) U.S. Cl. CPC G06Q 20/227; G06F 3/0482; G06Q 20/10; G06Q 20/326; G06Q 20/36; G06Q 20/3829; G06Q 20/4014

(57) ABSTRACT

An information processing device includes a recording unit that records address information of a plurality of wallets of a user including a custodial wallet and a non-custodial wallet in correlation with each other; and a control unit that switches, based on the address information, the wallet to be used among the plurality of wallets according to an operation by the user. The present technology can be applied to an information processing system.

### FIELD

The present technology relates to an information processing system, an information processing device and method, and a program, and in particular, to an information processing system, an information processing device and method, and a program that are capable of improving convenience.

### BACKGROUND

In recent years, the number of users who use services in blockchain-based metaverse, Web 3.0, and the like has been increasing.

In using such services, a user probably uses a plurality of wallets selectively for each service or the like. The need for selectively using such wallets is expected to increase in the future.

In addition, as a wallet-related technology, a technology for preventing leakage of a private key has also been proposed (see, for example, Patent Literature 1).

### CITATION LIST

### Patent Literature

Patent Literature 1: WO 2020/049951 A

### SUMMARY

### Technical Problem

In the meantime, currently, in providing various services and the like, the fact that a user has a plurality of wallets is not particularly taken into consideration. Accordingly, there is a demand for a technology to utilize a plurality of wallets without causing inconvenience to a user.

The present technology has been made in view of such a situation, and is intended to improve convenience.

### Solution to Problem

An information processing device of the first aspect of the present technology comprising:
a recording unit that records address information of a plurality of wallets of a user including a custodial wallet and a non-custodial wallet in correlation with each other; and
a control unit that switches, based on the address information, the wallet to be used among the plurality of wallets according to an operation by the user.

An information processing method or a program of the first aspect of the present technology comprising a step of:
switching, based on address information of a plurality of wallets of a user including a custodial wallet and a non-custodial wallet recorded in correlation with each other in a recording unit, the wallet to be used among the plurality of wallets according to an operation by the user.

In a first aspect of the present technology, to be switched, based on address information of a plurality of wallets of a user including a custodial wallet and a non-custodial wallet recorded in correlation with each other in a recording unit, the wallet to be used among the plurality of wallets according to an operation by the user.

An information processing device, for managing a private key of a custodial wallet of a user, of the second aspect of the present technology comprising:
a recording unit that records account information related to the custodial wallet of the user and address information of a non-custodial wallet of the user in correlation with each other;
a communication unit that acquires NFT information related to an NFT held in an account related to the non-custodial wallet of the user; and
an NFT information management unit that records, in the recording unit, the NFT information acquired, the address information of the non-custodial wallet, and the account information related to the custodial wallet of the user in the recording unit in correlation with each other, wherein
the communication unit transmits the NFT information recorded to a user terminal of the user.

An information processing method or a program of the second aspect of the present technology, comprising a step of:
by an information processing device managing a private key of a custodial wallet of a user and including a recording unit that records account information related to the custodial wallet of the user and address information of a non-custodial wallet of the user in correlation with each other,
acquiring NFT information related to an NFT held in an account related to the non-custodial wallet of the user;
recording, in the recording unit, the NFT information acquired, the address information of the non-custodial wallet, and the account information related to the custodial wallet of the user in correlation with each other; and
transmitting the NFT information recorded in the recording unit to a user terminal of the user.

In a second aspect of the present technology, an information processing device managing a private key of a custodial wallet of a user and including a recording unit that records account information related to the custodial wallet of the user and address information of a non-custodial wallet of the user in correlation with each other, executing a step of:
acquiring NFT information related to an NFT held in an account related to the non-custodial wallet of the user;
recording, in the recording unit, the NFT information acquired, the address information of the non-custodial wallet, and the account information related to the custodial wallet of the user in correlation with each other; and
transmitting the NFT information recorded in the recording unit to a user terminal of the user.

An information processing system of the third aspect of the present technology is an information processing system corresponding to the information processing device of the second aspect of the present technology.

### BRIEF DESCRIPTION OF DRAWINGS FIG. 1 is a diagram illustrating an example of the configuration of an information processing system.

FIG. 2 is a diagram illustrating an example of a display screen.

FIG. 3 is a diagram illustrating an example of a display screen.

FIG. 4 is a diagram illustrating an example of a display screen.

FIG. 5 is a diagram illustrating an example of a display screen.

FIG. 6 is a diagram illustrating an example of a display screen.

FIG. 7 is a diagram illustrating an example of a display screen.

FIG. 8 is a diagram illustrating an example of a display screen.

FIG. 9 is a diagram illustrating an example of a display screen.

FIG. 10 is a diagram illustrating an example of a display screen.

FIG. 11 is a diagram illustrating an example of a display screen.

FIG. 12 is a diagram illustrating an example of a display screen.

FIG. 13 is a diagram illustrating an example of a display screen.

FIG. 14 is a diagram illustrating an example of a display screen.

FIG. 15 is a diagram illustrating collection of NFT information.

FIG. 16 is a flowchart illustrating NFT information collection processing.

FIG. 17 is a flowchart illustrating NFT information collection processing and NFT information update processing.

FIG. 18 is a flowchart illustrating issuance request processing, issuance processing, and token recording processing.

FIG. 19 is a flowchart illustrating NFT information collection processing and NFT information transmission processing.

FIG. 20 is a flowchart illustrating registration request processing, NFT information transmission processing, and NFT information recording processing.

FIG. 21 is a flowchart illustrating NFT display processing and NFT information transmission processing.

FIG. 22 is a flowchart illustrating withdrawal request processing and response processing.

FIG. 23 is a diagram illustrating an example of the configuration of a computer.

### DESCRIPTION OF EMBODIMENTS

Hereinafter, embodiments to which the present technology is applied will be described with reference to the drawings.

### First Embodiment

### Configuration of Information Processing System

The present technology can improve convenience by easily switching between a plurality of wallets including a custodial wallet and a non-custodial wallet.

Generally, the procedure for purchasing a non-fungible token (NFT) for enjoyment is complicated, which makes it difficult for a user to easily use the NFT.

In order to purchase an NFT, the user first opens an account with a cryptocurrency exchange to exchange fiat currency for cryptocurrency, and sends the cryptocurrency to a crypto asset wallet. After sending the cryptocurrency, the user can connect the crypto asset wallet to an NFT marketplace and purchase an NFT with the cryptocurrency.

In this case, many procedures are necessary to purchase an NFT, and the procedure for sending the cryptocurrency to the crypto asset wallet is also complicated.

Further, for example, in a case where both a non-custodial wallet that is linked to services in blockchain-based metaverse and Web 3.0 and a custodial wallet that has undergone identity verification are selectively used, it is troublesome to manage and switch between these wallets.

Therefore, in the present technology, wallets used in modes such as one or a plurality of metaverse modes and a personal account mode, that is, wallets of a plurality of accounts are managed in correlation with each other, so that the plurality of wallets can be linked together. As a result, a plurality of modes (accounts) can be easily switched, which improves convenience.

Here, the metaverse mode is a mode in which one or a plurality of services in a digital world is used. The wallet in the metaverse mode corresponds to one or a plurality of services, for example, a wallet of a combat metaverse, and is a non-custodial wallet in which the user locally manages a private key. The non-custodial wallet is used in a service using a public blockchain (public chain) in which any user can participate.

In contrast, the personal account mode is a mode in which a real-world service such as crypto asset transaction is used with an account that has undergone identity verification by Know Your Customer (KYC) or the like. The wallet used in the personal account mode is a custodial wallet in which the serving side manages the private key. The custodial wallet is used in a service using a private blockchain (private chain) in which only a specific user can participate.

In the present technology, one or a plurality of non-custodial wallets and one custodial wallet are linked, so that switching to any wallet can be easily performed. Note that an example in which one custodial wallet is linked will be described, but two or more custodial wallets may be linked together.

In addition, the wallets are linked together, so that NFTs managed in a plurality of wallets such as a non-custodial wallet and a custodial wallet can be collectively displayed at the same time, or a crypto asset can be easily moved from any wallet to another wallet. Further, an NFT designated on the custodial wallet can be withdrawn to a non-custodial wallet, or the identity verification information of the custodial wallet can be used in a non-custodial wallet.

FIG. 1 is a diagram illustrating an example of the configuration of an embodiment of an information processing system to which the present technology is applied.

An information processing system 11 illustrated in FIG. 1 includes a user terminal 21, an external service server 22, and a custodial server 23.

The user terminal 21 is configured with an information processing device such as a smartphone, a tablet, or a personal computer owned by a user. For example, the user terminal 21 manages a private key of a non-custodial wallet of the user.

The user terminal 21 includes a display unit 31, an input unit 32, a control unit 33, a communication unit 34, a recording unit 35, and a non-custodial wallet management unit 36.

The display unit 31 displays any image such as a screen of a wallet application that implements a service in which a non-custodial wallet and a custodial wallet are linked according to an instruction from the control unit 33. The wallet application can also be said to be an application that uses a plurality of wallets including a non-custodial wallet and a custodial wallet, that is, user accounts (modes) corresponding to the plurality of wallets, by switching between them as appropriate.

The input unit 32 is configured with a button, a switch, a touch panel superimposed on the display unit 31, and the like, and supplies a signal corresponding to a user operation to the control unit 33.

The control unit 33 controls the entire operation of the user terminal 21. The communication unit 34 communicates with an external device such as the custodial server 23 or the external service server 22 via a network such as the Internet.

The recording unit 35 records any information such as information related to the wallet application. For example, the recording unit 35 records connection destination information for connecting to the custodial server 23, such as a uniform resource locator (URL) and an Internet protocol (IP) address, connection destination information for connecting to the external service server 22, and the like.

The recording unit 35 also records address information and private keys of non-custodial wallets used in one or a plurality of accounts of metaverse (metaverse mode), NFT information related to NFTs held in accounts related to the non-custodial wallets, account information such as an account ID of the user in the custodial server 23, and so on.

The account ID of the user in the custodial server 23 is identification information for uniquely identifying the user in the service provided by the custodial server 23.

The non-custodial wallet management unit 36 manages the non-custodial wallet of the user used in the metaverse mode.

The non-custodial wallet management unit 36 includes a private key generation unit 41, a private key management unit 42, an address management unit 43, and an NFT information management unit 44.

The private key generation unit 41 generates a private key of the non-custodial wallet based on a random number or the like. The private key management unit 42 manages the private key that is generated by the private key generation unit 41 and recorded in the recording unit 35.

The address management unit 43 manages the address information of the non-custodial wallet recorded in the recording unit 35. The NFT information management unit 44 manages NFT information, which is information related to NFTs held in the account related to the non-custodial wallet, recorded in the recording unit 35.

The external service server 22 is an information processing device managed by a business operator (service provider) that provides, as an external service, an NFT marketplace for selling NFTs and the like.

The external service server 22 includes a control unit 61, a communication unit 62, a recording unit 63, and an OFF-chain NFT management unit 64.

The control unit 61 controls the entire operation of the external service server 22. For example, the control unit 61 functions as a controller of a Web application programming interface (API) for providing an external service to the user terminal 21 and the custodial server 23.

The communication unit 62 communicates with an external device such as the user terminal 21 or the custodial server 23 via a network such as the Internet, and provides a Web API thereto.

The recording unit 63 functions as a relational database (RDB) that records any information necessary for providing an external service. For example, the recording unit 63 records NFT information related to NFTs that are in an OFF-chain state and are held by the user of the user terminal 21, account information related to the account of the user who uses an external service, and so on.

The OFF-chain state is a state where the NFT (data) has not yet been recorded in the blockchain.

Hereinafter, an NFT in the OFF-chain state, that is, an NFT recorded in the recording unit 63 of the external service server 22, is also particularly referred to as an OFF-chain NFT.

In contrast, an ON-chain state is a state where the NFT (data) is recorded in the blockchain. Hereinafter, an NFT in the ON-chain state, that is, an NFT in which the NFT data and the owner data, namely, the NFT information, is recorded on the blockchain is also particularly referred to as an ON-chain NFT.

The OFF-chain NFT managed by the external service server 22 becomes the ON-chain NFT when it is recorded in the blockchain by paying a fee and performing processing called withdrawal.

In the following, an example in which an NFT is recorded in a blockchain will be described, but the recording destination of the NFT is not limited thereto, and may be a P2P database or the like that is a distributed file system using a peer to peer (P2P) network.

The OFF-chain NFT management unit 64 manages the OFF-chain NFT recorded in the recording unit 63. The OFF-chain NFT management unit 64 includes an account management unit 71 and an NFT information management unit 72.

The account management unit 71 manages account information of the user for the external service recorded in the recording unit 63. The NFT information management unit 72 manages NFT information of the OFF-chain NFT of the user recorded in the recording unit 63.

The custodial server 23 is an information processing device managed by a business operator such as a cryptocurrency exchange. For example, the custodial server 23 manages a private key of the custodial wallet of the user.

The custodial server 23 provides the user with services such as transactions of crypto assets using the custodial wallet, and implements linkage between the custodial wallet and the non-custodial wallet. In particular, the custodial server 23 appropriately cooperates with the external service server 22 to implement data generation for ON-chain NFTs or OFF-chain NFTs, purchase of NFTs by the user, display of a list of NFTs held by the user, and the like.

Hereinafter, the description will be given assuming that a crypto asset transaction service, which is transactions of crypto assets, is provided by the custodial server 23.

The custodial server 23 includes a control unit 91, a communication unit 92, a recording unit 93, and a custodial wallet management unit 94.

The control unit 91 controls the entire operation of the custodial server 23. The communication unit 92 communicates with an external device such as the user terminal 21 or the external service server 22 via a network such as the Internet.

The recording unit 93 records any information such as information related to the wallet application.

For example, the recording unit 93 records information regarding a crypto asset transaction service, information regarding an external service, information regarding a non-custodial wallet of the user, and the like.

Here, the information regarding a crypto asset transaction service includes, for example, account information such as an account ID and a password of the user in the crypto asset transaction service, address information and a private key of a custodial wallet used in the crypto asset transaction service, user information used for identity verification at the time of opening an account in the crypto asset transaction service. For example, the user information that has undergone identity verification (KYC completed) includes the user's personal information such as the user's name, age, address, and telephone number.

Further, the information regarding an external service is, for example, connection destination information for connecting to the external service server 22, and the information regarding a non-custodial wallet is, for example, address information of the non-custodial wallet.

The custodial wallet management unit 94 manages the custodial wallet of the user used in the personal account mode.

The custodial wallet management unit 94 includes a private key generation unit 101, a private key management unit 102, an address management unit 103, a user information management unit 104, an external service account management unit 105, and an NFT information management unit 106.

The private key generation unit 101 generates a private key of the custodial wallet based on a random number or the like. The private key management unit 102 manages the private key that is generated by the private key generation unit 101 and recorded in the recording unit 93.

The address management unit 103 manages the address information of the custodial wallet recorded in the recording unit 93. The user information management unit 104 manages the user information and the account information for the crypto asset transaction service recorded in the recording unit 93.

The external service account management unit 105 manages information regarding an external service recorded in the recording unit 93. The NFT information management unit 106 manages NFT information, which is related to NFTs held in the account related to the non-custodial wallet of the user, recorded in the recording unit 93.

### Examples of Display Screen

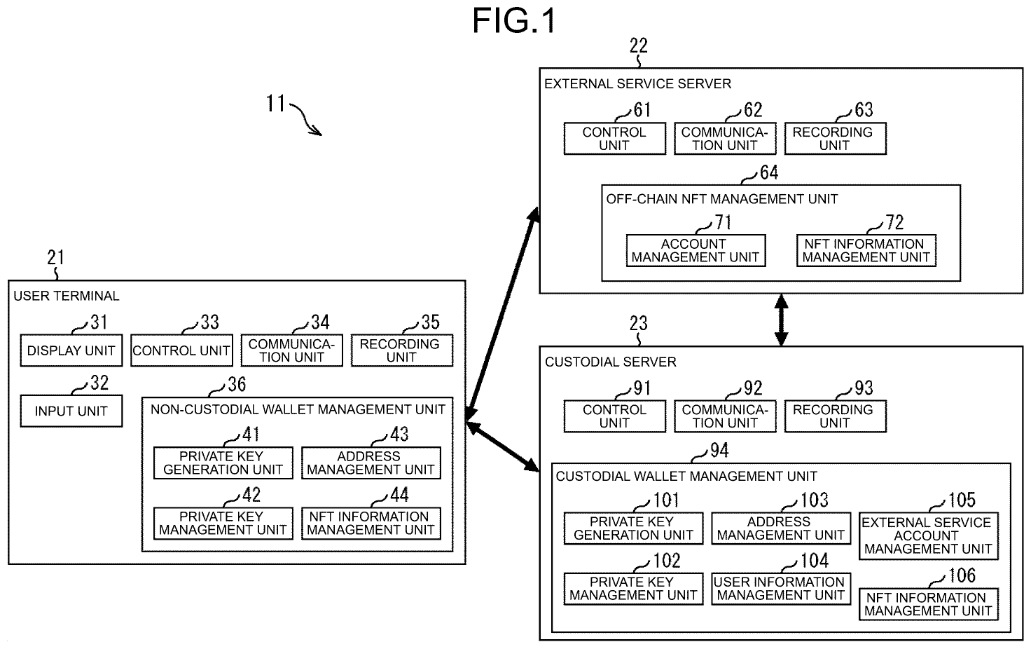

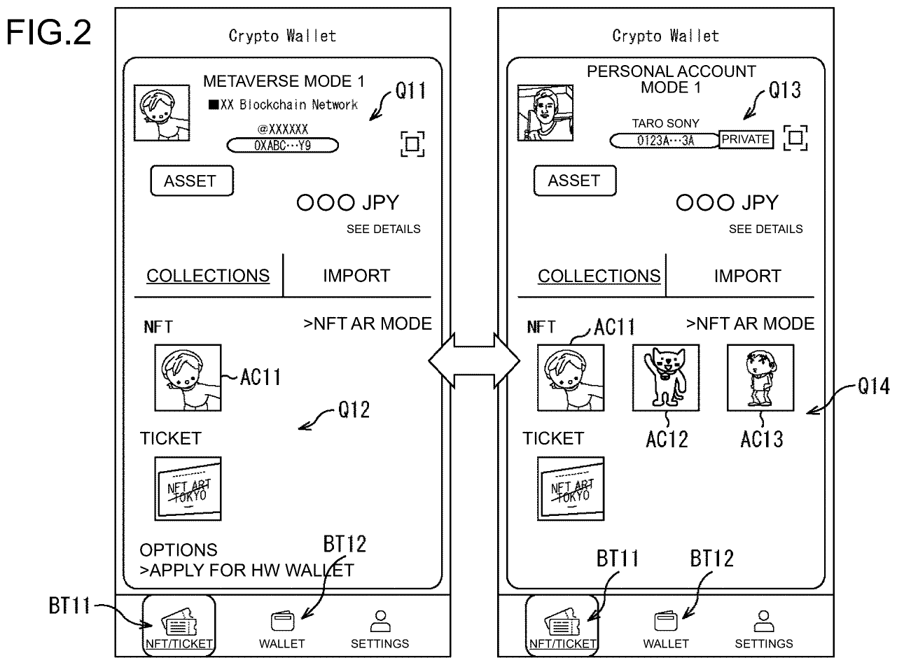

Examples of a display screen of a wallet application displayed on the user terminal 21 will be described with reference to FIGS. 2 to 14.

The display screens illustrated in FIGS. 2 to 14 are screens that the control unit 33 controls the display unit 31 to display according to a signal or the like supplied from the input unit 32 to the control unit 33 in response to a user operation on the input unit 32.

FIG. 2 illustrates a screen in the metaverse mode and a screen in the personal account mode.

In the drawing, a predetermined screen in the metaverse mode is illustrated on the left side, and the account name and the address information of the non-custodial wallet of the user in the metaverse mode are displayed at a part indicated by an arrow Q11 in the screen.

In the metaverse mode, the account name is set by the user, and for example, the default setting is that the address information of the non-custodial wallet is open to the public.

In addition, on the lower side of the account name and the address information in the drawing, the displayed account in the metaverse mode, that is, the asset held in the non-custodial wallet is also displayed.

Further, the NFT and the electronic ticket held in the displayed account (non-custodial wallet) in the metaverse mode are displayed at a part indicated by an arrow Q12. The electronic ticket may be anything such as an entrance ticket to an event.

In this example, for example, an icon AC11 is an image such as a thumbnail indicating the NFT held by the user in the non-custodial wallet, more specifically, in the account related to the non-custodial wallet.

In other words, the icon AC11 is an image representing content (NFT item) based on media data to which a certificate of ownership has been given. The media data is, for example, digital data of content such as a moving image, a still image, audio, or 3D data. In the present disclosure, an NFT item that is content or the like with a certificate of ownership is simply referred to as an NFT. The NFT item (NFT) is not limited to content, and may be anything such as various certificates of a certificate of participation in an event or membership.

On the screen in the metaverse mode, not only ON-chain NFTs but also OFF-chain NFTs are displayed. Note that the user may be able to set whether to display both ON-chain NFTs and OFF-chain NFTs or to display only one of them.

In addition, on the screen in the metaverse mode, a button BT11 with which to display the held NFT and electronic ticket, a button BT12 with which to select a wallet of the user, and the like are also displayed. For example, in response to the user operating the button BT11, the screen illustrated in FIG. 2 is displayed on the display unit 31.

Further, in a case where the user swipes in the left-right direction on the screen with the screen illustrated on the left side in the drawing displayed, for example, the screen on the display unit 31 switches to a screen in the personal account mode illustrated on the right side in the drawing. That is, the control unit 33 controls the display unit 31 to display the screen in the personal account mode illustrated on the right side in the drawing in response to the swipe operation by the user.

In this example, the account name and the address information of the custodial wallet of the user in the personal account mode are displayed at a part indicated by an arrow Q13, and the address information of the custodial wallet is generally not disclosed. In the personal account mode, the private key of the custodial wallet is managed by the custodial server 23, and it is thus unnecessary to manage the private key of the custodial wallet in the user terminal 21.

On the lower side of the account name and the address information in the drawing, the account in the personal account mode, that is, the asset held in the custodial wallet is also displayed.

Further, all the accounts including the metaverse mode and the personal account mode, that is, NFTs and electronic tickets held in all of the non-custodial wallets and the custodial wallet of the user are displayed at a part indicated by an arrow Q14.

In this example, the icons AC11 to AC13 representing NFTs are displayed side by side, whereby all the NFTs held by the user are displayed in a list form. In other words, the user can view other wallets in the custodial wallet as well, and more particularly, the NFTs held in the accounts related to other wallets of the user.

Here, for example, the NFT represented by the icon AC12 or the icon AC13 is an NFT held in a non-custodial wallet different from the non-custodial wallet in which the NFT represented by the icon AC11 is held.

On the screen in the personal account mode, not only ON-chain NFTs but also OFF-chain NFTs are displayed. Note that the user may be able to set whether to display both ON-chain NFTs and OFF-chain NFTs or to display only one of them.

When the list of the NFTs is displayed on the screen in the metaverse mode or the screen in the personal account mode, it may be possible to distinguish whether the NFT corresponding to each icon is the ON-chain NFT or the OFF-chain NFT depending on, for example, the color of the outer frame of the icon representing the NFT or the display location of the icon.

Similarly to the case of the screen in the metaverse mode, the button BT11 and the button BT12 are displayed on the screen in the personal account mode.

Here, an example is described in which there is one personal account mode, that is, there is one custodial wallet and there is a plurality of metaverse modes, that is, there is a plurality of non-custodial wallets will be described, but the number of custodial wallets and non-custodial wallets may be any number.

As described above, in the user terminal 21, the list of the NFTs held in the accounts related to all the plurality of wallets (modes) is displayed on the screen in the personal account mode, which enables the user to easily manage the NFTs held by the user.

In addition, the user can switch between the metaverse mode and the personal account mode, that is, between the user's own accounts by a simple operation such as a swipe operation, and can also easily manage information regarding the account such as an ID and a password for using a plurality of services such as a metaverse. This improves convenience.

The mode switching, that is, the wallet switching may be performed by any method, for example, by selecting an image of one desired card in a state where images of cards representing a plurality of wallets are displayed on the screen so that a wallet corresponding to the image is selected.

In addition, since there is a plurality of metaverse modes, the user can switch to another metaverse mode by performing a swipe operation on the screen while the screen in the metaverse mode or the personal account mode is displayed on the screen.

Such mode (account) switching, that is, wallet switching can be implemented by managing the account information and the wallet address of each mode in correlation with each other in the recording unit 93 of the custodial server 23.

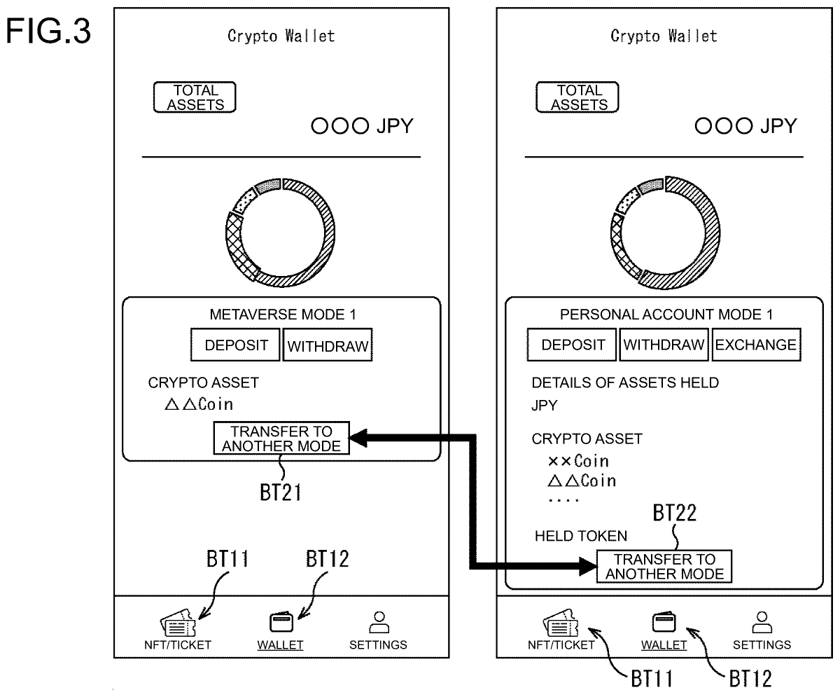

In addition, the user can operate the button BT12 to display a screen showing information regarding a crypto asset or the like managed in the wallet as illustrated in FIG. 3, for example.

On the left side of FIG. 3, a screen displayed when the user operates the button BT12 in a state where the screen illustrated on the left side of FIG. 2 is displayed is illustrated.

In FIG. 3, the screen illustrated on the left side displays information regarding a crypto asset of the user managed in the non-custodial wallet used in a predetermined metaverse mode.

The user can deposit money to the non-custodial wallet, withdraw money from the non-custodial wallet, transfer money to another wallet, or the like by operating a button on the screen.

Specifically, for example, the user can operate a button BT21 to transfer the crypto asset held in the non-custodial wallet in the metaverse mode currently displayed (selected) to a wallet used in another mode of the user himself/herself, that is, another metaverse mode or the personal account mode. In this case, a status during transfer may be displayed on a user interface (UI).

In FIG. 3, the screen illustrated on the right side displays information regarding the crypto assets and the held token of the user managed in the custodial wallet used in the personal account mode.

The held token herein is, for example, a dedicated coin that can be used in a predetermined service, application, or the like. For example, the user may be able to use a fan-exclusive service because he/she owns such a token. The held token may be on a public chain or on a private chain.

The user can deposit money to the custodial wallet, withdraw money from the custodial wallet, exchange money for another currency, transfer money to another wallet, or the like by operating a button on the screen.

Specifically, for example, the user can operate a button BT22 to transfer the crypto asset held in the custodial wallet in the personal account mode to another mode of the user himself/herself, that is, the non-custodial wallet used in any metaverse mode. In this case also, a status during transfer may be displayed on the UI.

As described above, in the user terminal 21, it is possible to easily transfer an asset (crypto asset) from any mode of the user to another mode of the user only by operating the screen of the wallet application. In other words, the transfer between the modes can be easily performed. In particular, in this example, the user only needs to perform the button operation, which makes it possible to reduce the occurrence of a transfer mistake due to an input error of the address information of the wallet or the like.

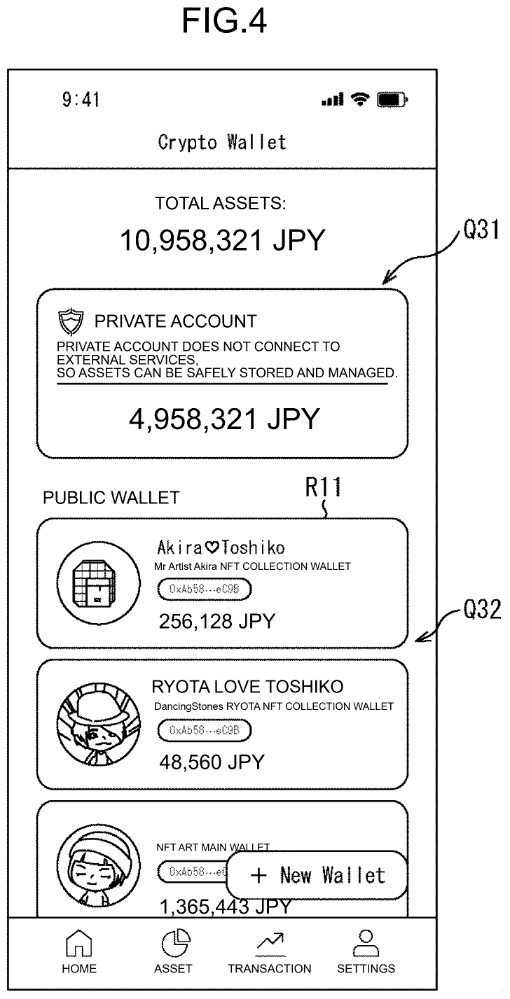

The present technology is not limited to the examples illustrated in FIGS. 2 and 3, and for example, the screen illustrated in FIG. 4 may be displayed on the display unit 31 of the user terminal 21 as the display screen of the wallet application.

In the example illustrated in FIG. 4, at a part indicated by an arrow Q31 on the screen related to the wallet application, information regarding an account in the user's personal account mode (private account), in other words, information regarding the custodial wallet is displayed.

In particular, in this example, the total amount of fiat currency and crypto assets managed in the private account (custodial wallet) is displayed. The private account becomes available after identity verification (KYC).

At a part indicated by an arrow Q32, one or a plurality of public wallets used by the user is listed.

Here, one public wallet is one non-custodial wallet created by the user for each purpose such as using a service in the metaverse or the Web 3.0.

A public wallet may be created for each service such as a metaverse, or one public wallet may be used in common for a plurality of services. The user can set an account name and the like for each public wallet, and for example, in the custodial server 23, the account ID of the private account and the address information of the public wallet are managed in correlation with each other.

For example, in a region R11, information regarding one public wallet is displayed. In this example, the account name, the address information of the public wallet, the total amount of assets held in the public wallet, and the like are displayed as the information regarding the public wallet.

As described above, in the example of FIG. 4, a wallet list in which the private account (custodial wallet) owned by the user and a plurality of public wallets (non-custodial wallets) are displayed as a list (tile display) is displayed as the screen related to the wallet application.

The user can easily select the private account or any public wallet by operating (tapping) an area related to any wallet in the wallet list. That is, the user can easily switch between the wallets.

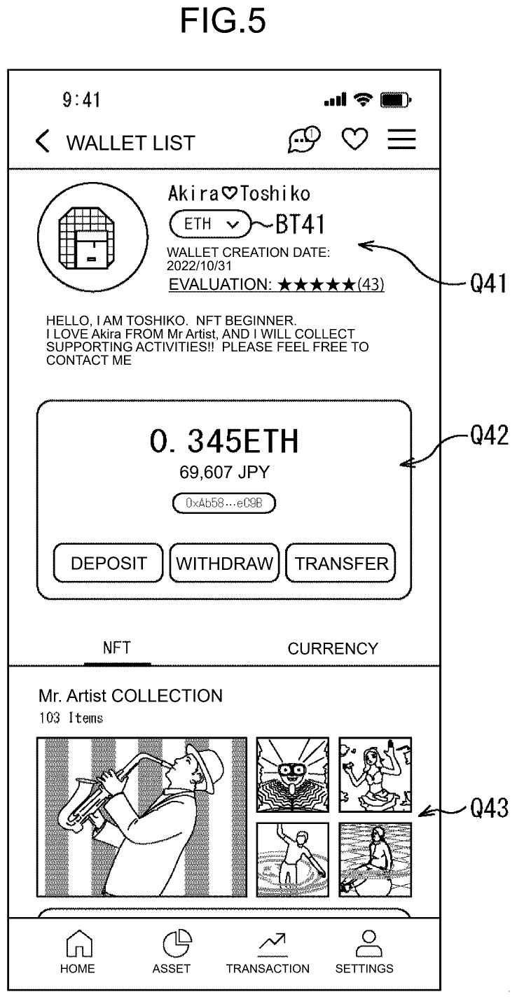

Specifically, for example, when the user taps a part corresponding to the region R11, the display on the display unit 31 switches to, for example, a screen illustrated in FIG. 5.

In the example of FIG. 5, information regarding a public wallet (non-custodial wallet) corresponding to the region R11 of FIG. 4 is displayed.

In this example, the account name, the wallet creation date, the user introduction, and the like in the public wallet are displayed at a part indicated by an arrow Q41, and the user can operate a pull-down list BT41 to select a crypto asset (virtual currency) to be displayed in a part indicated by an arrow Q42. Such display of the part indicated by the arrow Q41 enables forming a personality (identity) in the public wallet.

At the part indicated by the arrow Q42, information regarding the crypto asset selected in the pull-down list BT41 among the crypto assets held in the public wallet is displayed.

In this example, an amount of the owned crypto asset, address information of the public wallet, a button with which to deposit money into the public wallet, buttons with which to withdraw and transfer money from the public wallet are displayed.

At a part indicated by an arrow Q43, the NFTs held in the public wallet are listed. In this case, the NFTs held may be grouped for each artist or the like, and the NFTs for each group may be displayed in a list. As with the case of FIG. 2, the user may be able to set whether to display both ON-chain NFTs and OFF-chain NFTs or to display only one of them.

Further, the user can switch between the tabs to display information regarding the held crypto assets such as a list of the crypto assets held in the public wallet at the part indicated by the arrow Q43.

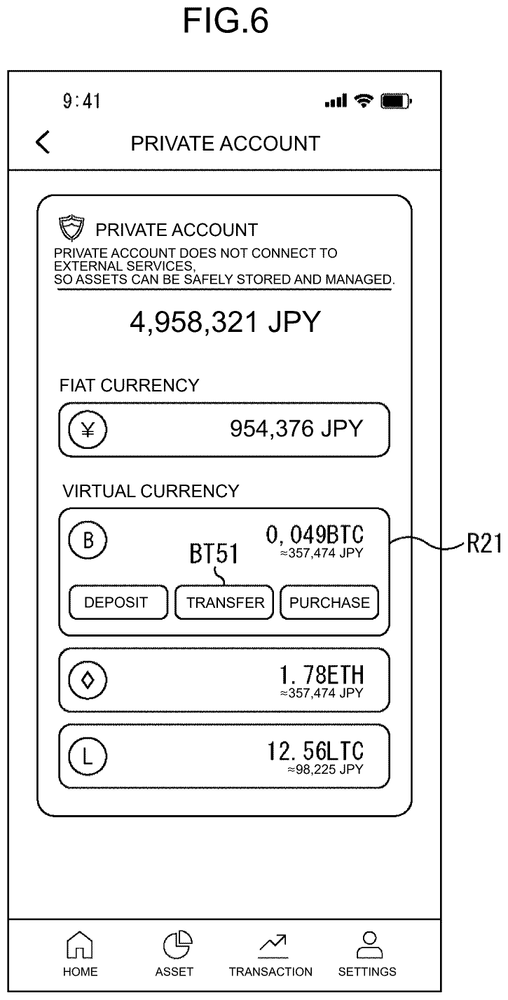

When the user taps the part indicated by the arrow Q31 in a state where the screen illustrated in FIG. 4 is displayed on the display unit 31, the display on the display unit 31 switches to, for example, a screen illustrated in FIG. 6.

In the example of FIG. 6, information regarding the private account is displayed. In particular, herein, information such as the total amount of assets held in the private account, the holding amount of fiat currency, and the holding amount of each virtual currency (crypto asset) is displayed.

For example, at a part indicated by a region R21, information regarding one virtual currency such as the holding amount of one virtual currency held in the custodial wallet as the private account is displayed.

Further, buttons for depositing, transferring, and purchasing a virtual currency are also provided at the part indicated by the region R21.

For example, the user can operate a button BT51 provided at the part indicated by the region R21 to transfer the virtual currency (crypto asset) held in the private account (custodial wallet) to any public wallet (non-custodial wallet) of the user.

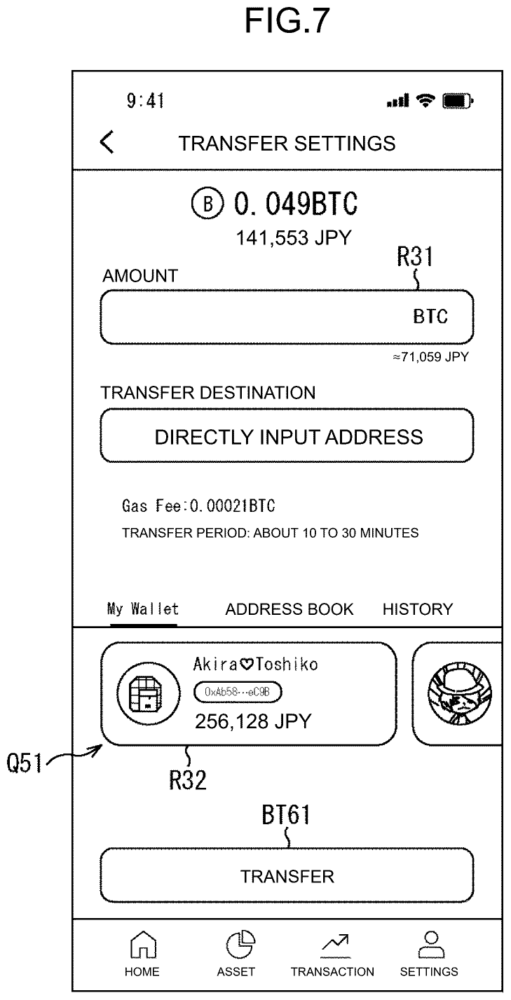

In response to the user operating the button BT51, for example, a screen illustrated in FIG. 7 is displayed on the display unit 31.

The screen illustrated in FIG. 7 is a screen for designating a transfer destination and a transfer amount of the crypto asset. For example, the user inputs the transfer amount in a part corresponding to a region R31 in the screen. Further, the user can designate the transfer destination by directly inputting address information of the wallet that is the transfer destination or selecting the wallet that is the transfer destination from the wallet list.

For example, at a part indicated by an arrow Q51, a list of potential wallets for the transfer destination is displayed. In this example, a plurality of public wallets of the user is displayed as the potential wallets for the transfer destination.

For example, in a region R32, information regarding one public wallet that is the potential wallet for the transfer destination is displayed. In this example, the account name, the address information of the public wallet, the total amount of assets held in the public wallet, and the like are displayed as the information regarding the public wallet.

Further, the user can switch between tabs to display, as a list of wallets that are potential wallets for the transfer destination, a list of wallets registered in the address book, a list of wallets selected as the transfer destination in the past, and the like at the part indicated by the arrow Q51.

Further, when the user inputs the transfer amount, designates a wallet as the transfer destination, and then operates a transfer button BT61 provided on the lower side of the screen, the crypto asset of the designated amount is actually transferred from the private account (custodial wallet) to the designated wallet. When the actual transfer processing is performed, the transfer status may be displayed on the UI.

According to the examples illustrated in FIGS. 4 to 7 as described above, it is possible to seamlessly connect (link) the private account to the public wallet, to easily perform transfer between wallets, purchase of an NFT, trade, and the like, which improves convenience.

In addition, the user can perform various settings by operating setting buttons provided on the lower right side of the screens illustrated in FIGS. 4 to 7.

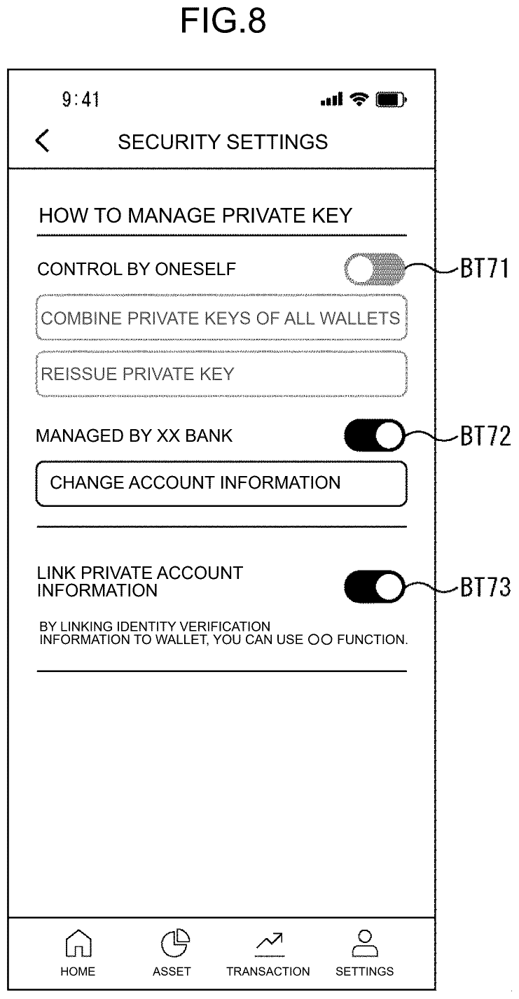

Specifically, for example, the user can display a screen illustrated in FIG. 8 and perform settings regarding security in the wallet application.

In the example illustrated in FIG. 8, the user can operate a toggle button BT71 to set whether to manage the private key of the user's public wallet (non-custodial wallet) in the user terminal 21 (by himself/herself).

In a case where the user makes settings so that the private key of the public wallet is not managed in the user terminal 21 (by himself/herself) by using the toggle button BT71, he/she can operate a toggle button BT72 to set whether to manage the private key of the public wallet in the custodial server 23.

With such settings, it is possible to request the custodial server 23 to manage the private key of the public wallet, which is generally performed in the user terminal 21, resulting in the increased security.

Further, in the example of FIG. 8, the user can operate a toggle button BT73 to set whether to use the identity verification information of the private account, that is, the user information that has undergone identity verification (KYC completed) in the public wallet.

If the user information that has undergone identity verification (KYC completed) recorded in the recording unit 93 of the custodial server 23 can also be used in the public wallet, reliability can be increased in a case where NFT transactions are performed between users, or the like.

For example, in a case where the user information that has undergone identity verification (KYC completed) is mutually disclosed between users, the communication unit 34 of the user terminal 21 transmits, to the custodial server 23, a request to transmit the user information. When the communication unit 92 receives the request to transmit the user information, the user information management unit 104 of the custodial server 23 reads the user information from the recording unit 93, supplies the user information to the communication unit 92, and causes the communication unit 92 to transmit the user information to the user terminal 21.

When the communication unit 34 receives (acquires) the user information, the user terminal 21 supplies the user information to the non-custodial wallet management unit 36, and transmits the user information to the user terminal to which the user information is to be disclosed, the external service server 22, or the like via the communication unit 34. That is, the control unit 33 transmits, via the communication unit 34, the user information that has undergone identity verification to an external device at the time of using a predetermined service in the metaverse mode in which the non-custodial wallet is used, and thereby the user information that has undergone identity verification is used as information regarding the user.

Further, the communication unit 34 of the user terminal 21 receives user information of the partner user transmitted from the disclosure destination. As a result, both the users can browse the user information that has undergone identity verification (KYC completed) of the partner user.

At this time, not only the user information but also information regarding the account of the user in the metaverse mode may be mutually transmitted and received.

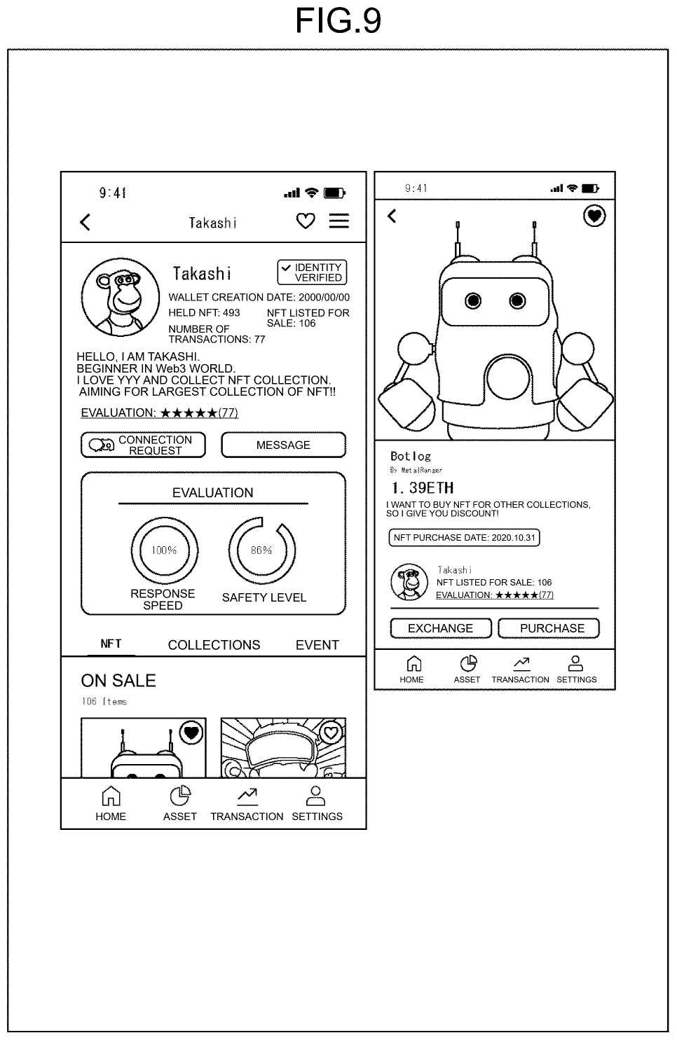

For example, in a case where the user information is mutually disclosed in the NFT marketplace, the user can display a screen illustrated on the left side of FIG. 9 on the display unit 31 and confirm user information that has undergone identity verification (KYC completed) of another user.

In this example, as for a predetermined user, an account name of the user, user introduction (self-introduction), rating from another person, a mark indicating that the identity has been verified, and so on in the public wallet are displayed. The user information displayed herein is information with high reliability because the user information has undergone identity verification.

In addition, a list of NFTs being offered for sale by the predetermined user is displayed on the lower side of the screen in the drawing.

When a user selects a desired NFT from the list of NFTs being offered for sale, for example, as illustrated on the right side in the drawing, information related to the selected NFT can be viewed on the screen displayed on the display unit 31. In this example, the NFT, the selling price, the text message of the seller, and the like are displayed, and a button used for exchanging or purchasing the NFT is also displayed.

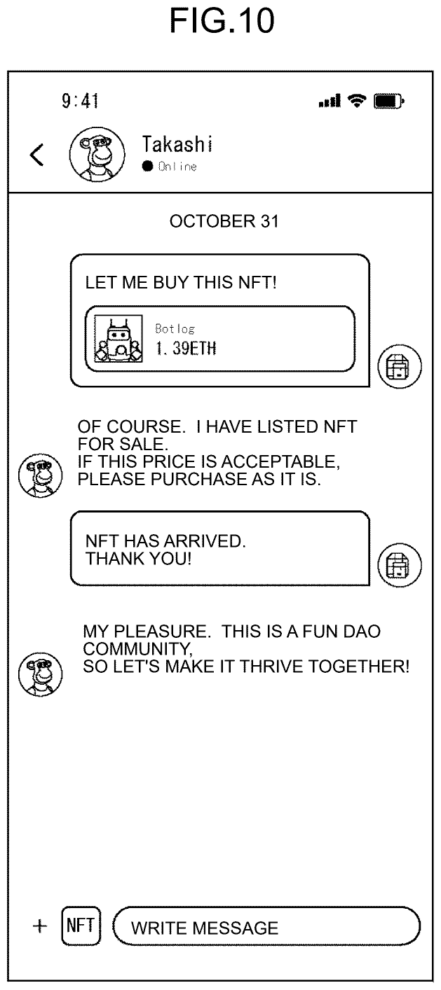

Further, the user can operate a message button provided on the screen illustrated on the left side in the drawing to exchange text messages with another user who is a seller of the NFT as illustrated in FIG. 10, for example.

In this way, if the user can directly interact with the seller of the NFT, the user can purchase the NFT with peace of mind. Moreover, when buying and selling (trading) NFTs, both the seller and the buyer can confirm the user information that has undergone identity verification with high reliability, so that the transaction can be performed with security.

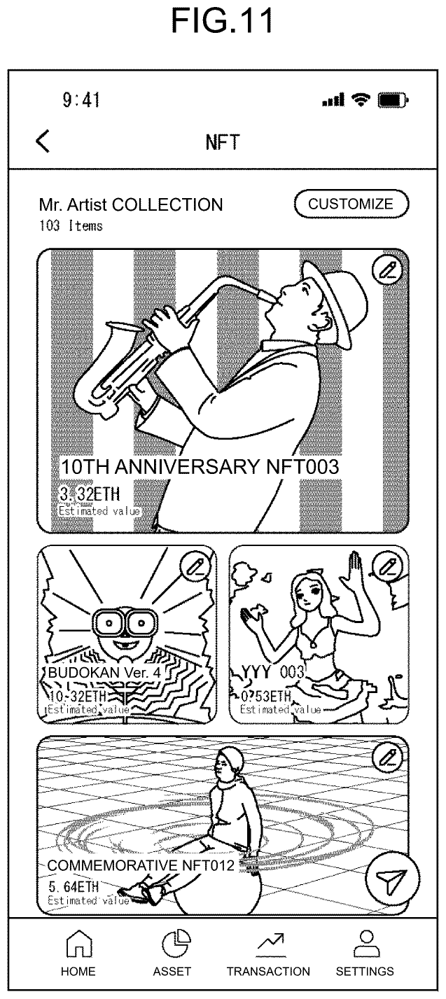

Further, for example, as illustrated in FIG. 11, the user may operate a customization button or the like on the display screen of My gallery on which one or a plurality of purchased NFTs is displayed so that the display in My gallery can be customized according to his/her preference.

Note that the user information may be mutually disclosed not only in the NFT marketplace but also in a communication space such as a fan community.

As described above, by mutual disclosure of the user information, users can securely connect to each other in a place such as an NFT marketplace or a fan community, which allows the users to trade and exchange NFTs with peace of mind.

In addition, an electronic ticket such as an entrance ticket to a predetermined event can also be purchased with the non-custodial wallet of the user.

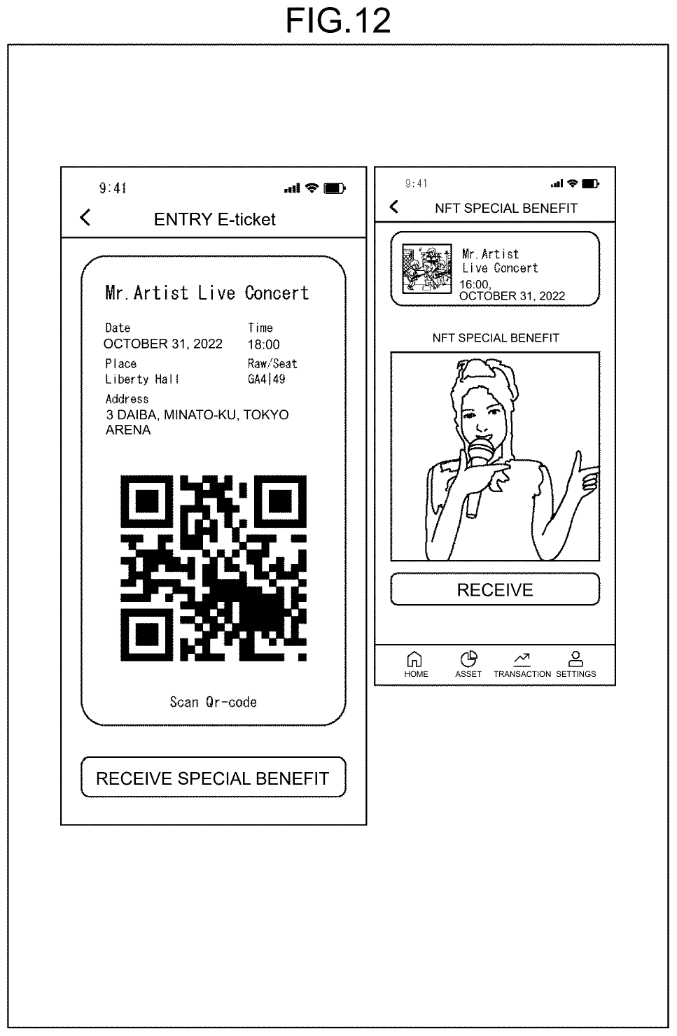

In such a case, for example, as illustrated on the left side of FIG. 12, an electronic ticket purchased by the user can be displayed on the display unit 31 of the user terminal 21.

In this example, information such as an event name, a date and time, and a venue is displayed as the information of the electronic ticket. In addition, a quick response (QR) code (registered trademark) used at the time of entering the event venue and a button for receiving a special benefit for the event are also displayed on the screen illustrated in FIG. 12.

When the user operates a button to receive the special benefit, for example, a screen illustrated on the right side in the drawing is displayed on the display unit 31. On this screen, an NFT that can be received as the benefit and a receive button for receiving the benefit are displayed, and the user can actually receive the benefit NFT by operating the receive button.

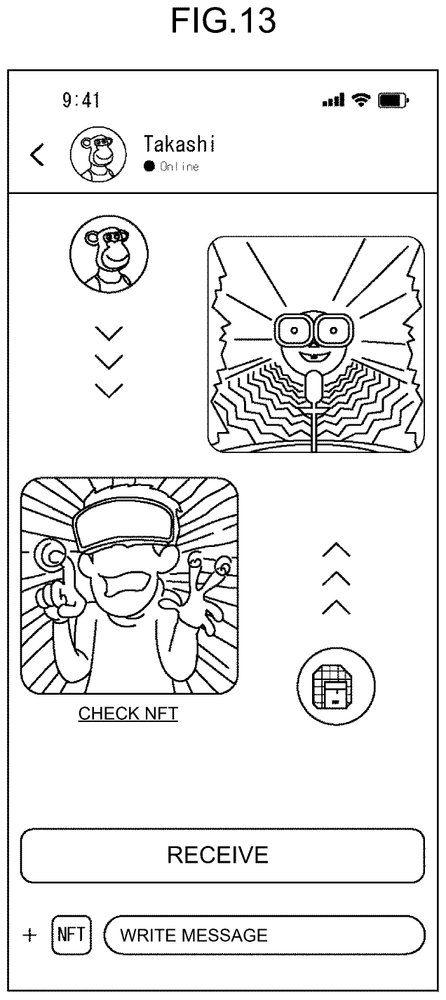

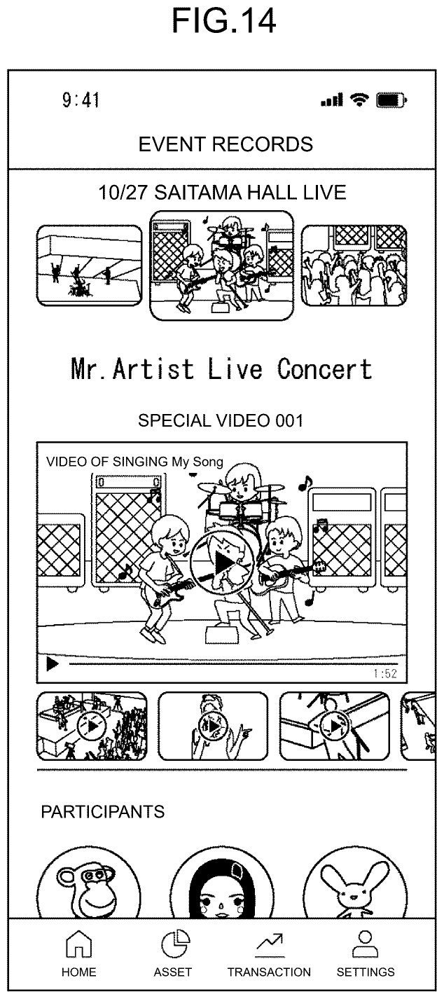

Further, at an event or the like, for example, as illustrated in FIG. 13, the users may be able to mutually exchange the held NFTs using an application of a fan community. Further, for example, as illustrated in FIG. 14, a moving image or a message may be shared on a page dedicated to the event so that fans participating in the event can interact with each other. Even in the NFT exchange or the interaction between the fans, the exchange or the interaction can be performed with more security by appropriately disclosing the user information that has undergone identity verification.

### About Collection of NFT Information

As described above, the user terminal 21 can display a list of all the wallets of the user, more specifically, a list of NFTs held in the accounts corresponding to all the wallets of the user.

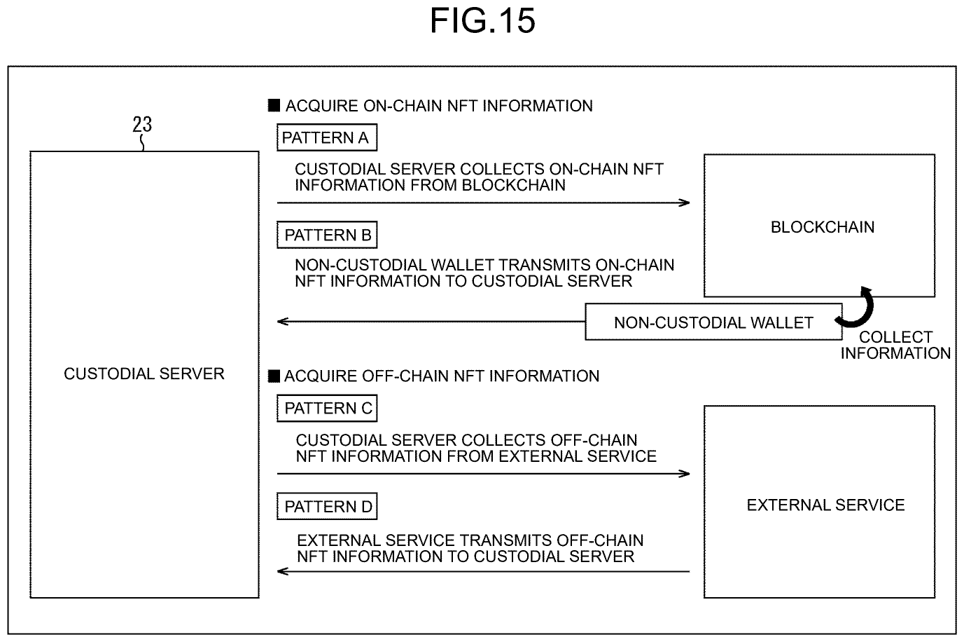

In displaying such a list of NFTs, it is necessary for the custodial server 23 to collect NFT information of ON-chain NFTs and OFF-chain NFTs. For example, possible examples of the collection method include four methods illustrated in FIG. 15.

In FIG. 15, methods of pattern A and pattern B are illustrated as the methods of collecting NFT information of ON-chain NFTs, and methods of pattern C and pattern D are illustrated as the methods of collecting NFT information of OFF-chain NFTs.

In pattern A, the custodial server 23 collects the NFT information of ON-chain NFTs from the blockchain.

The blockchain herein is a public chain that records a transaction (data) in which NFT information related to NFTs held in non-custodial wallets is stored.

In pattern B, NFT information of ON-chain NFTs is collected from the blockchain by a non-custodial wallet, i.e., the user terminal 21, and the collected NFT information is transmitted from the user terminal 21 to the custodial server 23. In pattern B, only the necessary amount can be collected when necessary, so that the overall processing load can be reduced.

In pattern C, the custodial server 23 collects the NFT information of OFF-chain NFTs from an external service, that is, the external service server 22.

In pattern D, the external service, that is, the external service server 22 transmits the NFT information of OFF-chain NFTs to the custodial server 23. In pattern D, the development load on the external service side can be reduced as compared with pattern C.

### Pattern A

Next, processing performed in patterns A to D will be described.

First, pattern A will be described.

For example, in a transaction recorded in the blockchain, at least the following information is stored as the information related to an NFT, that is, NFT information.
Contract address
Token name
Token symbol
Token ID
Metadata URL
Owner information

The contract address is an address on the blockchain in which a smart contract for managing the NFT is disposed.

The token name and the token symbol are names representing the NFT. In particular, the token symbol is a symbol (code) in which a name (token name) representing the NFT is represented in a shorter character string such as about three English letters.

The token ID is an ID for identifying the NFT given to a minted (issued) NFT. In particular, the token ID is an ID that uniquely identifies the NFT in the same contract. The metadata URL is information indicating where to acquire the metadata. The metadata is data in which explanation of the NFT, a reference (URL) to media data such as image data, and the like are described, and the metadata is, for example, a data file in a JavaScript Object Notation (JSON) format or the like.

The owner information is address information indicating a wallet address holding the NFT. Here, a transaction (NFT information) in which the address information of the non-custodial wallet of the user is stored as the owner information is a collection target.

In the recording unit 93 of the custodial server 23, the account information of the user in the custodial server 23 (crypto asset transaction service) and the address information of the non-custodial wallet of the user are recorded in correlation with (in association with) each other.

That is, in the custodial server 23 (wallet application), the account information related to the user account in the custodial server 23, in other words, the custodial wallet of the user, and the non-custodial wallet of the same user are correlated in advance. As a result, the custodial wallet and the non-custodial wallet of different accounts of the same user are linked.

Further, in the recording unit 35 of the user terminal 21, address information of the non-custodial wallet used in the metaverse mode, connection destination information of the custodial server 23, an account ID of the user in the custodial server 23, and the like are recorded in advance.

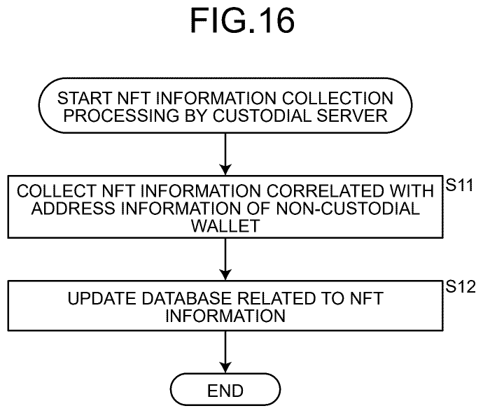

In such a case, in pattern A, for example, NFT information collection processing illustrated in FIG. 16 is performed by the custodial server 23 to thereby collect the NFT information of ON-chain NFTs from the blockchain.

Hereinafter, the NFT information collection processing by the custodial server 23 will be described with reference to the flowchart of FIG. 16.

The NFT information collection processing may be performed at any timing such as a periodic timing or a timing when an instruction is given from the user terminal 21.

In Step S11, the control unit 91 collects (crawls) the NFT information correlated with the address information of the non-custodial wallet of the user.

For example, the control unit 91 reads, from the recording unit 93, the address information of all the non-custodial wallets recorded in correlation with the account information (custodial wallet) of the user in the custodial server 23.

Then, the control unit 91 controls the communication unit 92 to read a transaction (data) including the address information of the non-custodial wallet of the user as the owner information and the NFT information from the blockchain. That is, the communication unit 92 receives the transaction transmitted from the blockchain to supply the transaction to the control unit 91. In this case, transactions are read for each non-custodial wallet of the user.

As a result, the transactions related to one or all the ON-chain NFTs held in the non-custodial wallet of the user, that is, the NFT information is read (acquired).

In particular, here, as the NFT information, a contract address, a token name, a token symbol, a token ID, and a metadata URL related to the NFT are read. Further, as necessary, the metadata is acquired based on the metadata URL, and the URL of the media data is also acquired from the metadata.

In Step S12, the NFT information management unit 106 updates a database related to the NFT information. That is, the NFT information management unit 106 records the NFT information in the recording unit 93.

For example, in the recording unit 93, the database related to NFT information (hereinafter, referred to as an NFT database) is managed. In the NFT database, as for ON-chain NFTs and OFF-chain NFTs, the NFT information collected so far, the address information of the non-custodial wallet, and the account information of the user in the custodial server 23 are stored (recorded) in correlation with each other.

The NFT information management unit 106 compares the NFT information or the like stored in the NFT database with the NFT information collected in Step S11, and updates or adds the information related to the NFT information for the NFT to which the information has been updated or added.

For example, in a case where there is an NFT for which a part or all of the NFT information or the owner information has been updated, the NFT information management unit 106 replaces, for that NFT, information of an updated part of the NFT information stored in correlation with the NFT database, the address information of the non-custodial wallet, and the account information of the user with the latest information (collected information).

Further, in a case where there is an NFT newly held, that is, an added NFT, the NFT information management unit 106 correlates, for that NFT, the NFT information, the address information of the non-custodial wallet, and the account information of the user and stores (adds) the resultant in the NFT database.

When the NFT database is updated in this manner, the NFT information collection processing ends.

As described above, the custodial server 23 collects the NFT information related to ON-chain NFTs held in the non-custodial wallet based on the address information of the non-custodial wallet correlated with the account information (account ID) in the custodial server 23 of the user.

### Pattern B

In pattern B, the NFT information is collected from the blockchain by the user terminal 21, that is, each non-custodial wallet of the user.

In this case, in the recording unit 35 of the user terminal 21, address information of the non-custodial wallet used in the metaverse mode, connection destination information of the custodial server 23, an account ID of the user in the custodial server 23, and the like are recorded in advance.

As with the case of pattern A, in the recording unit 93 of the custodial server 23, the account information of the user in the custodial server 23 and the address information of the non-custodial wallet of the user are recorded in correlation with each other.

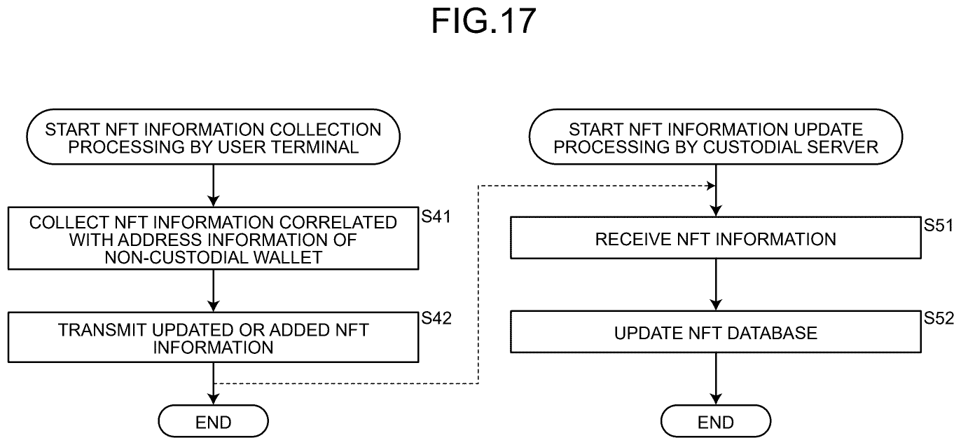

Then, the processing illustrated in FIG. 17 is performed by the user terminal 21 and the custodial server 23, and NFT information of ON-chain NFTs is collected.

Hereinafter, NFT information collection processing by the user terminal 21 and NFT information update processing by the custodial server 23 will be described with reference to the flowchart of FIG. 17.

Note that the NFT information collection processing and the NFT information update processing described with reference to FIG. 17 may be performed at any timing such as a periodic timing or a timing at which the user terminal 21 connects to the custodial server 23 in the metaverse mode.

When the NFT information collection processing is started in the user terminal 21, the processing of Step S41 is performed. In Step S41, the control unit 33 of the user terminal 21 collects, based on the address information of the non-custodial wallet in the metaverse mode, the NFT information correlated with the address information.

For example, in Step S41, processing similar to that in Step S11 of FIG. 16 is performed, and the NFT information correlated with the address information of the non-custodial wallet in the metaverse mode is read from the blockchain.

As a result, the communication unit 34 reads, as the NFT information, a contract address, a token name, a token symbol, a token ID, a metadata URL, and owner information related to the NFT from the blockchain.

Further, the control unit 33 accesses the metadata URL via the communication unit 34 to acquire the metadata, acquires the URL of the media data from the metadata, or accesses the URL of the media data via the communication unit 34 to acquire the media data, as necessary.

The NFT information management unit 44 updates, based on the collected NFT information, the information related to the NFT recorded in the recording unit 35 regarding the NFT to which the information has been updated or added.

For example, regarding the NFT information collected by the user terminal 21 so far, the NFT information and the address information of the non-custodial wallet are recorded in the recording unit 35 in correlation with each other. In addition, in the recording unit 35, the address information of the non-custodial wallet of the user and the account information (account ID) of the account in the custodial server 23 of the user are recorded in correlation with each other.

In particular, the NFT information herein includes at least a contract address, a token name, a token symbol, a token ID, and a metadata URL. In addition, owner information, metadata, media data, and the like can also be included in the NFT information.

The NFT information management unit 44 compares the NFT information or the like recorded in the recording unit 35 with the NFT information collected in Step S41, and updates or adds the information related to the NFT information recorded in the recording unit 35 for the NFT to which the information has been updated or added.

Further, the NFT information management unit 44 reads, from the recording unit 35, the account information of the user in the custodial server 23 correlated with the address information of the non-custodial wallet. Then, regarding the NFT to which the information has been updated or added, the NFT information management unit 44 supplies the NFT information collected in Step S41, the address information of the non-custodial wallet, and the account information of the user in the custodial server 23 to the communication unit 34 as transmission information. The NFT information management unit 44 instructs the communication unit 34 to transmit the supplied transmission information to the custodial server 23.

In Step S42, the communication unit 34 transmits, to the custodial server 23, the transmission information supplied from the NFT information management unit 44, that is, the updated or added NFT information, the address information of the non-custodial wallet, and the account information of the user.

For example, the NFT information management unit 44 controls the communication unit 34, based on the connection destination information recorded in the recording unit 35, to connect to the custodial server 23 and transmit the transmission information using the Web API of the custodial server 23.

When the NFT information or the like is transmitted as the transmission information as described above, the NFT information collection processing ends.

Note that the NFT information collection processing is performed for each metaverse mode, more specifically, for each non-custodial wallet.

Further, when the processing of Step S42 is performed, the custodial server 23 performs the NFT information update processing.

That is, in Step S51, the communication unit 92 receives the updated or added NFT information, the address information of the non-custodial wallet, and the account information of the user that have been transmitted as the transmission information from the user terminal 21. In other words, the communication unit 92 acquires the NFT information from the user terminal 21.

In Step S52, the NFT information management unit 106 updates the NFT database in the recording unit 93 based on the NFT information, the address information of the non-custodial wallet, and the account information of the user received in Step S51.

That is, the NFT information management unit 106 correlates the updated or added NFT information, the address information of the non-custodial wallet, and the account information of the user in the custodial server 23 with one another to store the resultant in the NFT database (record the resultant in the recording unit 93).

Every time the NFT information is added or updated, the added or updated NFT information is stored in the NFT database. As a result, all the latest NFT information on the blockchain is stored in the NFT database. When the NFT database is updated in this manner, the NFT information update processing ends.

As described above, the user terminal 21 collects the NFT information related to ON-chain NFTs held in the non-custodial wallet, and transmits the updated or added NFT information to the custodial server 23. Further, the custodial server 23 receives the NFT information transmitted from the user terminal 21 to update the NFT database.

### Pattern C

In pattern C, the custodial server 23 collects the NFT information of OFF-chain NFTs from an external service (external service server 22).

In this case, access token information of the external service is registered in the custodial server 23 by the wallet application in order to prevent unauthorized access.

The access token information is an authorization token necessary to access the external service server 22, more specifically, the API of the external service server 22, and is issued for each account of the external service, for example, after authentication with the external service.

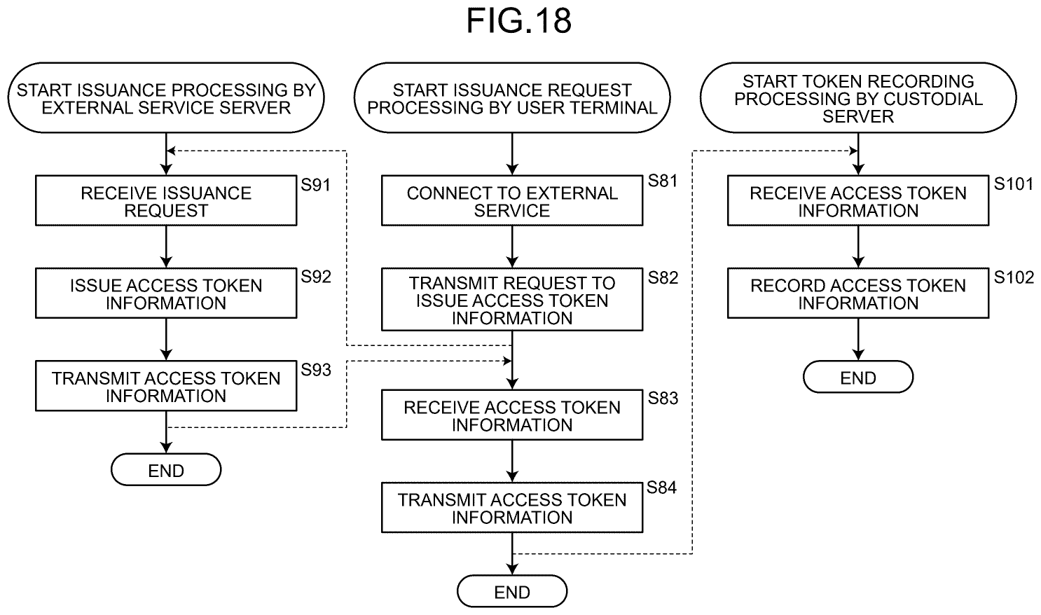

For example, when the access token information is registered, the processing illustrated in FIG. 18 is performed. Hereinafter, issuance request processing by the user terminal 21, issuance processing by the external service server 22, and token recording processing by the custodial server 23 will be described with reference to the flowchart of FIG. 18.

When the issuance request processing is started in the user terminal 21, the processing of Step S81 is performed.

In Step S81, the control unit 33 controls the communication unit 34 based on the connection destination information of the external service server 22 and the address information of the non-custodial wallet recorded in the recording unit 35, and connects to the external service server 22 (external service) with the non-custodial wallet in the metaverse mode.

In addition, when the user operates the input unit 32 to perform an operation for requesting issuance of access token information for connection to an external service on the wallet application, the control unit 33 generates a request to issue access token information in accordance with a signal from the input unit 32 and supplies the request to the communication unit 34.

In Step S82, the communication unit 34 transmits the request to issue access token information supplied from the control unit 33 to the external service server 22.

Responding to this, the external service server 22 starts the issuance processing and performs the processing of Step S91.

In Step S91, the communication unit 62 receives the issuance request transmitted from the user terminal 21 and supplies the issuance request to the control unit 61.

In Step S92, in response to the issuance request supplied from the communication unit 62, the control unit 61 issues access token information to the account of the user for the external service, that is, the non-custodial wallet used in the account of the user.

As necessary, the control unit 61 supplies the issued access token information to the recording unit 63 to record the access token information, and supplies the access token information to the communication unit 62 to instruct the communication unit 62 to transmit the same to the user terminal 21. In this case, for example, the access token information is recorded in correlation with the account information related to the account of the user for the external service or the address information of the non-custodial wallet as appropriate.

In Step S93, the communication unit 62 transmits the access token information supplied from the control unit 61 to the user terminal 21, and the issuance processing ends.

When the processing of Step S93 is performed, the processing of Step S83 is performed in the user terminal 21.

In Step S83, the communication unit 34 receives the access token information transmitted from the external service server 22 and supplies the access token information to the control unit 33.

In addition, the control unit 33 connects to the custodial server 23 via the communication unit 34 based on the connection destination information of the custodial server 23 recorded in the recording unit 35, and instructs the communication unit 34 to transmit the access token information to the custodial server 23.

In Step S84, the communication unit 34 transmits the access token information received in Step S83 to the custodial server 23 according to the instruction from the control unit 33, and the issuance request processing ends.

When the processing of Step S84 is performed, the token recording processing is started in the custodial server 23, and the processing of Step S101 is performed.

In Step S101, the communication unit 92 receives the access token information transmitted from the user terminal 21. That is, the communication unit 92 acquires the access token information from the user terminal 21.

In Step S102, the external service account management unit 105 supplies the access token information received in Step S101 to the recording unit 93 to cause the recording unit 93 to record the same. At this time, for example, the access token information is stored in the NFT database in correlation with the address information of the non-custodial wallet.

When the access token information is recorded (registered) in the custodial server 23 in this manner, the token recording processing ends. The above processing is performed for each account of the user for the external service, that is, for each non-custodial wallet.

When the access token information is registered, the custodial server 23 can access the external service server 22 with the access token information at any timing to collect the NFT information of OFF-chain NFTs held in the account related to the non-custodial wallet.

In this case, the NFT information of OFF-chain NFTs held in the account of the user is recorded in the recording unit 63 of the external service server 22 in correlation with the account information related to the account of the user for the external service and the address information of the non-custodial wallet.

Here, for example, a contract address, a token name, a token symbol, a token ID, metadata, and the like for OFF-chain NFTs are recorded in the recording unit 63 as the NFT information.

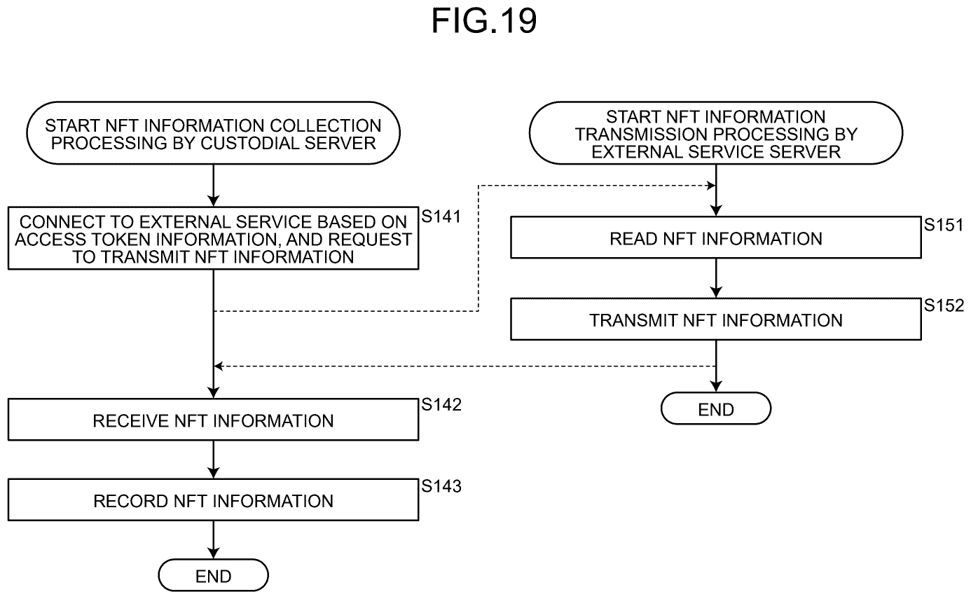

In a case where the custodial server 23 collects the NFT information of OFF-chain NFTs based on the access token information, for example, the processing illustrated in FIG. 19 is performed. Hereinafter, NFT information collection processing by the custodial server 23 and NFT information transmission processing by the external service server 22 will be described with reference to the flowchart of FIG. 19.

When the NFT information collection processing by the custodial server 23 is started, the processing of Step S141 is performed.

In Step S141, the control unit 91 connects to an external service, that is, the external service server 22 based on the access token information and the connection destination information of the external service server 22 recorded in the recording unit 93, and requests the external service server 22 to transmit the NFT information of OFF-chain NFTs.

For example, the control unit 91 controls the communication unit 92 to transmit the access token information to the external service server 22, and to connect to the OFF-chain NFT information acquisition API of the external service to thereby request to transmit the NFT information.

Then, in the external service server 22, the NFT information transmission processing is started in response to the request from the custodial server 23, and the processing of Step S151 is performed.

In Step S151, the NFT information management unit 72 reads the NFT information of OFF-chain NFTs of the user from the recording unit 63.

For example, the NFT information management unit 72 identifies, in the recording unit 63, the account information of the user for the external service and the address information of the non-custodial wallet correlated with the access token information used for the connection in Step S141.

Then, the NFT information management unit 72 reads the NFT information of OFF-chain NFTs recorded in correlation with the identified account information and the identified address information of the non-custodial wallet from the recording unit 63 and supplies the NFT information to the communication unit 62.

Here, for example, a contract address, a token name, a token symbol, a token ID, metadata, and the like for OFF-chain NFTs are read as the NFT information. In this case, the token ID may be key information or the like that can uniquely identify the NFT in the external service.

In Step S152, the communication unit 62 transmits the NFT information supplied from the NFT information management unit 72 to the custodial server 23, and the NFT information transmission processing ends.

Further, when the NFT information is transmitted, the custodial server 23 performs the processing of Step S142.

In Step S142, the communication unit 92 receives the NFT information transmitted from the external service server 22. As a result, the communication unit 92 acquires the NFT information from the external service server 22 based on the access token information.

In Step S143, the NFT information management unit 106 supplies the NFT information received in Step S142 to the recording unit 93 and causes the recording unit 93 to record the NFT information.

At this time, the NFT information management unit 106 correlates the NFT information of OFF-chain NFTs received (acquired), the address information of the non-custodial wallet, and the account information of the user in the custodial server 23 with one another to store (record) the resultant in the NFT database.

In particular, in this example, the NFT information correlated with the address information of the non-custodial wallet in the NFT database is overwritten each time the processing of Step S143 is performed. As a result, the NFT information of the NFTs that were collected in the past and have been withdrawn at the present time is prevented from remaining in the NFT database as the NFT information of OFF-chain NFTs.

As described above, the custodial server 23 collects the NFT information of OFF-chain NFTs from the external service server 22 using the access token information issued by the external service server 22 and acquired from the user terminal 21.

### Pattern D

In pattern D, the external service (external service server 22) transmits the NFT information of OFF-chain NFTs to the custodial server 23.

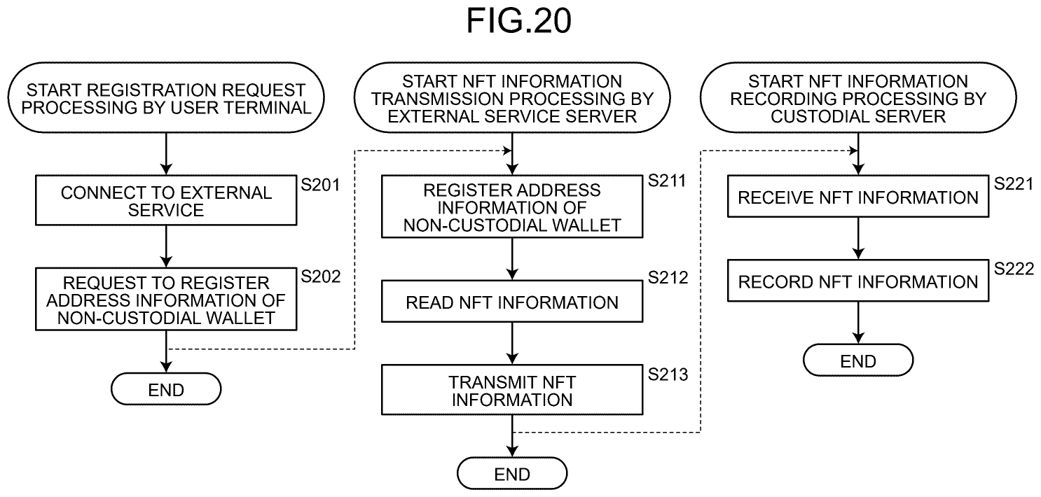

In this case, the processing illustrated in FIG. 20 is performed in the user terminal 21, the external service server 22, and the custodial server 23.

Hereinafter, registration request processing by the user terminal 21, NFT information transmission processing by the external service server 22, and NFT information recording processing by the custodial server 23 will be described with reference to the flowchart of FIG. 20.

When the registration request processing is started in the user terminal 21, the processing of Step S201 is performed.

In Step S201, the control unit 33 controls the communication unit 34 based on the connection destination information of the external service server 22 and the address information of the non-custodial wallet recorded in the recording unit 35, and connects to the external service server 22 (external service) with the non-custodial wallet in the metaverse mode.

When the user operates the input unit 32 to perform an operation for requesting registration of the address information of the non-custodial wallet to the external service, the control unit 33 generates a request to generate the address information according to a signal from the input unit 32 and supplies the request to the communication unit 34 together with the address information.

In Step S202, the communication unit 34 transmits, to the external service server 22, the address information of the non-custodial wallet and the request to generate the address information supplied from the control unit 33, thereby requesting the external service server 22 to register the address information of the non-custodial wallet. When the registration request is transmitted, the registration request processing ends.

In the external service server 22, when the address information and the registration request transmitted in Step S202 are received by the communication unit 62, that is, when registration of the address information is requested, the NFT information transmission processing is started and the processing of Step S211 is performed.

In Step S211, the control unit 61 registers the address information of the non-custodial wallet requested by the user terminal 21, that is, the address information of the non-custodial wallet connected to the external service server 22.

Specifically, the control unit 61 registers the address information by supplying the recording unit 63 with the received address information of the non-custodial wallet and causing the recording unit 63 to record the address information. In this case, for example, the address information of the non-custodial wallet is recorded in correlation with the account information related to the account of the user for the external service as appropriate.

When the address information is completely registered, thereafter, the processing of Step S212 is performed at any timing.

In Step S212, the NFT information management unit 72 reads, from the recording unit 63, the registered address information of the non-custodial wallet of the user and the NFT information of OFF-chain NFTs held by the account of the user for the external service correlated with the address information.

For example, the NFT information management unit 72 reads the registered address information of the non-custodial wallet in the recording unit 63 and identifies the account information of the user for the external service correlated with the address information.

Then, the NFT information management unit 72 reads the NFT information of OFF-chain NFTs recorded in correlation with the identified account information and the identified address information of the non-custodial wallet from the recording unit 63 and supplies the NFT information to the communication unit 62 together with the address information of the non-custodial wallet.

Here, for example, a contract address, a token name, a token symbol, a token ID, metadata, and the like for OFF-chain NFTs are read as the NFT information. In this case, the token ID may be key information or the like that can uniquely identify the NFT in the external service.

In Step S213, the communication unit 62 transmits the NFT information and the address information of the non-custodial wallet supplied from the NFT information management unit 72 to the custodial server 23, and the NFT information transmission processing ends.

Note that the custodial server 23 to which the NFT information is to be transmitted may be registered in advance, and the connection destination information of the custodial server 23 may be recorded in the recording unit 63, or the custodial server 23 to which the NFT information is to be transmitted may be designated by the user terminal 21.

When the NFT information is transmitted, the custodial server 23 starts the NFT information recording processing, and performs the processing of Step S221.

In Step S221, the communication unit 92 receives the NFT information and the address information of the non-custodial wallet transmitted from the external service server 22. That is, the communication unit 92 acquires the NFT information and the like by receiving the NFT information and the address information of the non-custodial wallet from the external service server 22.

In Step S222, the NFT information management unit 106 supplies the recording unit 93 with the NFT information and the address information of the non-custodial wallet received in Step S221 to cause the recording unit 93 to record the same.

For example, in the recording unit 93, the account information of the user in the custodial server 23 and the address information of the non-custodial wallet of the user are recorded in correlation with each other in advance. Accordingly, the NFT information management unit 106 can identify the account information in the custodial server 23 of the user correlated with the address information of the non-custodial wallet received in Step S221.

The NFT information management unit 106 correlates the NFT information of OFF-chain NFTs received (acquired), the address information of the non-custodial wallet, and the account information of the user in the identified custodial server 23 with one another to store the resultant in the NFT database.

The NFT information correlated with the address information of the non-custodial wallet in the NFT database is overwritten each time the processing of Step S222 is performed, similarly to the case of Step S143 in FIG. 19.

As described above, the custodial server 23 collects the NFT information of OFF-chain NFTs by receiving the NFT information of OFF-chain NFTs transmitted from the external service server 22.

The example in which the NFT information is collected for both ON-chain NFTs and OFF-chain NFTs has been described above. However, the present technology is not limited thereto, and it is only required that the NFT information is collected for NFTs in at least one of the OFF chain and the ON-chain states.

### Display List of NFTs

As described above, when the processing of pattern A or pattern B and the processing of pattern C or pattern D are performed, the NFT information of all the NFTs held by the user is recorded in the custodial server 23.

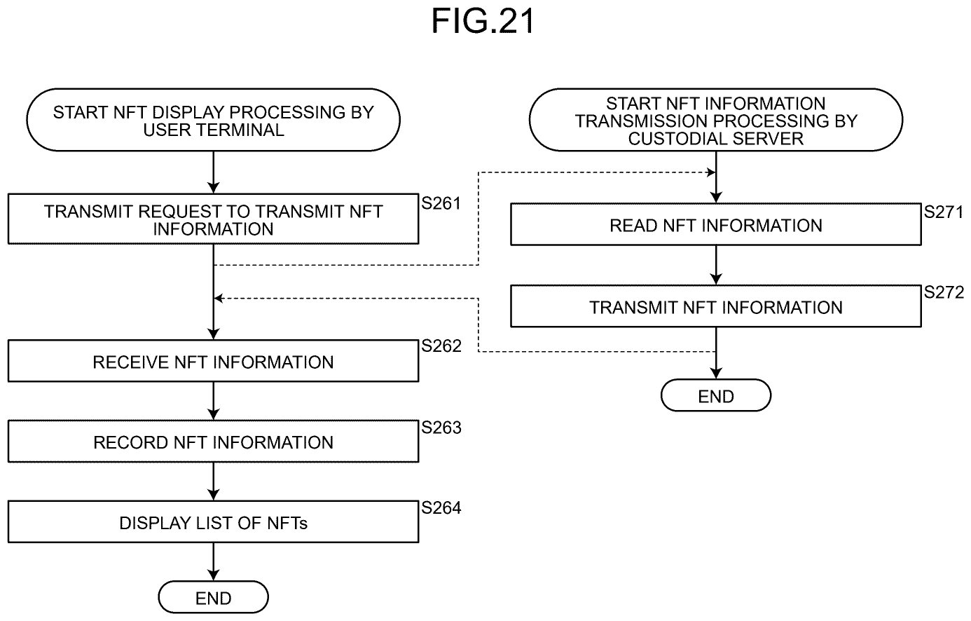

Therefore, by using the NFT information of all the NFTs, a list of the NFTs can be displayed in the user terminal 21. In such a case, for example, the processing illustrated in FIG. 21 is performed.

Hereinafter, NFT display processing by the user terminal 21 and NFT information transmission processing by the custodial server 23 will be described with reference to the flowchart of FIG. 21.

For example, in the user terminal 21, after the wallet application is activated, the NFT display processing is started at a predetermined timing such as a timing when the account mode is set to the personal account mode, that is, a timing when connection to the custodial server 23 is made with the custodial wallet, and the processing of Step S261 is performed.

In Step S261, the communication unit 34 transmits a request to transmit NFT information to the custodial server 23. That is, the control unit 33 controls the communication unit 34 to transmit the request to transmit NFT information in a state of being connected to the custodial server 23 with the custodial wallet, thereby requesting the custodial server 23 to transmit the NFT information correlated with the account information of the user.

In the custodial server 23, when the communication unit 92 receives the transmission request from the user terminal 21, the NFT information transmission processing is started, and the processing of Step S271 is performed.

In Step S271, the NFT information management unit 106 reads the NFT information of all the NFTs correlated with the account information (account ID) of the user in the custodial server 23 from the NFT database of the recording unit 93, and supplies the NFT information to the communication unit 92.

As a result, the NFT information collected by the custodial server 23 is read for all the ON-chain NFTs and OFF-chain NFTs held by the user. Here, the NFT information includes a contract address, a token name, a token symbol, a token ID, a metadata URL, metadata, and media data.

In Step S272, the communication unit 92 transmits the NFT information supplied from the NFT information management unit 106 to the user terminal 21, and the NFT information transmission processing ends.

When the NFT information is transmitted, in Step S262, the communication unit 34 of the user terminal 21 receives the NFT information transmitted from the custodial server 23. That is, the communication unit 34 acquires, from the custodial server 23, the NFT information related to all the NFTs held in the accounts related to the plurality of wallets of the user.

Note that, in the transmission and reception of the NFT information, it is possible to identify which user's account (wallet) each piece of received (acquired) NFT information is held in, whether each piece of received (acquired) NFT information is ON chain, and other states.

For example, the NFT information may be transmitted in a state where address information of a wallet or information indicating an NFT state such as an ON chain is correlated with the NFT information.

In Step S263, the NFT information management unit 44 supplies the NFT information received in Step S262 to the recording unit 35 and causes the recording unit 35 to record the NFT information.

At this time, if necessary, the communication unit 34 may acquire the metadata based on the metadata URL as the NFT information, or may acquire the media data based on the URL of the media data included in the metadata, and the metadata and the media data may also be recorded as the NFT information.

In Step S264, the control unit 33 displays a list of NFTs on the display unit 31 based on the NFT information of each NFT recorded in the recording unit 35, and the NFT display processing ends.

As a result, the display unit 31 displays a list of all the ON-chain NFTs and OFF-chain NFTs held by the user on the display screen in the personal account mode. That is, all the NFTs held in the non-custodial wallet or the like are listed in the custodial wallet. Specifically, for example, the screen illustrated on the right side of FIG. 2 is displayed on the display unit 31.

Note that, as described above, among all the NFTs held in each of the plurality of accounts of the user, NFTs in at least one of the OFF chain and the ON chain may be displayed as a list. In this case, the user may select whether to display a list of only OFF chain NFTs, a list of only ON chain NFTs, or a list of both OFF chain NFTs and ON chain NFTs.

As described above, the user terminal 21 receives the NFT information from the custodial server 23 to display a list of the NFTs held in all the modes. As a result, even in the personal account mode, the user can confirm the NFTs held by the user in another mode (metaverse mode), which improves convenience.

In addition, the recording unit 35 manages (records) the account information (account ID) of the user in the custodial server 23 and the address information of the custodial wallet in correlation with the address information of one or a plurality of non-custodial wallets. Therefore, the user can switch between the wallets (modes) with a simple operation to thereby improve convenience.

Note that, in the recording unit 35, address information of a plurality of wallets including a custodial wallet and a non-custodial wallet may be recorded in advance in correlation with each other.

Further, as another example, the account information (account ID) of the user in the custodial server 23 and the address information of one or a plurality of non-custodial wallets of the user may be recorded in advance in the recording unit 35 in correlation with each other.

In such a case, for example, at a timing when the user terminal 21 accesses the custodial server 23 or the like, the address information of the custodial wallet is acquired (received) from the custodial server 23 based on the account ID by the communication unit 34. Then, the acquired address information of the custodial wallet is correlated with the address information of one or a plurality of non-custodial wallets, and the resultant is temporarily recorded in the recording unit 35.

For instance, in the example of FIG. 2, the display unit 31 displays, as a screen related to the wallet application, a screen in a mode selected by the user such as the metaverse mode or the personal account mode, in other words, a screen in a mode in which the wallet selected by the user is used.

In this case, when the user swipes in the left-right direction on the screen, the control unit 33 changes the wallet to be used among the plurality of wallets according to a signal supplied from the input unit 32 in response to the operation by the user based on the address information of the wallet recorded in the recording unit 35. As a result, the wallet and the mode are changed by the control unit 33. In addition, the control unit 33 causes the display unit 31 to display a screen in the mode in which the changed wallet is used.

In this case, for example, the wallet to be used is switched from the custodial wallet to the non-custodial wallet, or is switched from the non-custodial wallet to another non-custodial wallet. In other words, the mode to be used is switched from the personal account mode to the metaverse mode, or is switched from the metaverse mode to another metaverse mode.

Similarly, for example, also in the example illustrated in FIG. 4, the user can select a desired wallet from among the plurality of wallets including the custodial wallet and the non-custodial wallet displayed as a list (tile display) on the display unit 31.

Also in this case, the control unit 33 changes the wallet to be used to the wallet selected by the user according to a signal from the input unit 32 based on the address information of the wallet recorded in the recording unit 35. That is, the mode is switched to the mode selected by the user.

### Withdrawal of OFF-Chain NFT

Further, for example, the user can select (designate) a desired OFF-chain NFT held in any mode and withdraw the OFF-chain NFT in a state where a list of NFTs is displayed on the screen in the personal account mode such as the screen illustrated on the right side of FIG. 2.

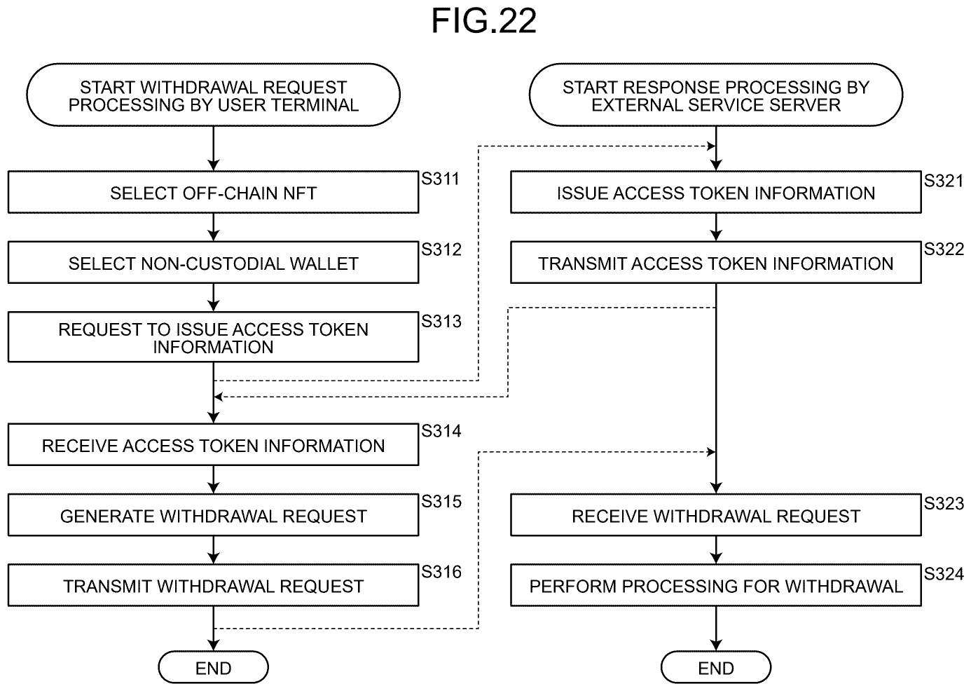

In such a case, the user terminal 21 and the external service server 22 perform the processing illustrated in FIG. 22. Hereinafter, withdrawal request processing by the user terminal 21 and response processing by the external service server 22 will be described with reference to a flowchart of FIG. 22.

In the user terminal 21, when the user selects an NFT to be withdrawn on the display screen in the personal account mode, the withdrawal request processing is started, and the processing of Step S311 is performed.

In Step S311, the control unit 33 selects the OFF-chain NFT to be withdrawn according to a signal supplied from the input unit 32 in response to the selection operation by the user. That is, the OFF-chain NFT to be withdrawn in the custodial wallet is selected.

Further, the user selects the NFT to be withdrawn, and then operates the input unit 32 to select the non-custodial wallet to which the NFT is to be withdrawn.

In Step S312, the control unit 33 selects the non-custodial wallet to which the OFF-chain NFT selected in Step S311 is to be withdrawn according to a signal supplied from the input unit 32 in response to the selection operation by the user.

The user operates the input unit 32 to access the external service at an appropriate timing such as before or after selecting the withdrawal destination, and causes the display unit 31 to display an authentication screen for the external service.

In this case, the control unit 33 causes the communication unit 34 to access the external service server 22 to receive the display data for the authentication screen based on, for example, the connection destination information of the external service server 22 recorded in the recording unit 35. In addition, the control unit 33 supplies the received display data to the display unit 31 to display the authentication screen.

When the authentication screen is displayed, the user operates the input unit 32 to input, as authentication information, information for authenticating the user, such as the account ID and the password of the user for the external service.

In Step S313, the control unit 33 supplies the authentication information to the communication unit 34 to cause the communication unit 34 to transmit the authentication information to the external service server 22 according to a signal from the input unit 32 in response to the operation by the user, and requests the issuance of access token information for the non-custodial wallet selected in Step S312.

For example, the control unit 33 controls the communication unit 34 to transmit the authentication information to an authentication API of the external service server 22. In addition, the address information of the non-custodial wallet is transmitted to the external service server 22 via the communication unit 34 as necessary.

Responding to this, the external service server 22 starts the response processing and performs the processing of Step S321.

In Step S321, the control unit 61 performs authentication based on the authentication information received from the user terminal 21, and issues access token information to the non-custodial wallet. The control unit 61 supplies the access token information to the recording unit 63 as necessary, and causes the recording unit 63 to record the access token information in correlation with the account information of the user for the external service or the like.

Further, the control unit 61 supplies the issued access token information to the communication unit 62, and instructs the communication unit 62 to transmit the access token information to the user terminal 21.

In Step S322, the communication unit 62 transmits the access token information supplied from the control unit 61 to the user terminal 21.

Then, the user terminal 21 performs the processing of Step S314. In Step S314, the communication unit 34 receives the access token information transmitted from the external service server 22.

In Step S315, the control unit 33 generates a withdrawal request.

For example, the control unit 33 reads, from the recording unit 35, the NFT information of the OFF-chain NFT to be withdrawn selected in Step S311 and the address information of the non-custodial wallet selected in Step S312.

Then, the control unit 33 generates a withdrawal request that includes the read NFT information and the address information of the non-custodial wallet and requests execution of withdrawal of the OFF-chain NFT. At this time, the withdrawal request includes, for example, the contract address and the token ID of the OFF-chain NFT as the NFT information.

In Step S316, the control unit 33 supplies the access token information received in Step S314 and the generated withdrawal request to the communication unit 34, and transmits the withdrawal request to the external service server 22 (withdrawal API) based on the access token information.

Then, the external service server 22 performs the processing of Step S323. In Step S323, the communication unit 62 receives the withdrawal request transmitted from the user terminal 21.

In Step S324, the control unit 61 executes processing for withdrawal while exchanging information with the user terminal 21 as appropriate.

Specifically, for example, in response to the received withdrawal request, the control unit 61 performs withdrawal processing of the OFF-chain NFT identified by the token ID contained in the withdrawal request.

For example, the control unit 61 generates signature information for verifying that the request to execute the transaction processing is legitimate, supplies the signature information to the communication unit 62, and causes the communication unit 62 to transmit the signature information to the user terminal 21, and appropriately performs processing related to updating of the NFT information and a fee in the recording unit 63. Note that, in a case where the transaction processing is transfer, transmission source address information is also transmitted to the user terminal 21 in addition to the signature information.

The communication unit 34 of the user terminal 21 receives the signature information transmitted from the external service server 22. Further, the control unit 33 issues (generates) a transaction based on the received signature information.

For example, the transaction includes NFT information of the OFF-chain NFT to be withdrawn, address information of the non-custodial wallet to which the NFT is to be withdrawn, and the signature information received from the external service server 22.

In particular, in this example, the contract address and the token ID are stored in the transaction as the NFT information of the OFF-chain NFT to be withdrawn. Further, the address information of the non-custodial wallet included in the transaction is the owner information.

Further, in a case where the transaction processing is transfer, the transmission source address information is also stored in the transaction. In addition, a token name, a token symbol, a metadata URL, and the like may be stored in the transaction.

The control unit 33 supplies the generated transaction to the communication unit 34, and the communication unit 34 transmits the transaction to the withdrawal contract (smart contract) on the blockchain indicated in the contract address.

Then, the withdrawal contract verifies the validity of the transaction based on the signature information included in the transaction received from the user terminal 21, and, when the verification is successful, the withdrawal processing (mint or transfer) of the transaction, that is, transaction processing is executed.

As a result, the transaction is recorded in the blockchain, and the NFT and the address information of the non-custodial wallet are correlated with each other. In other words, the NFT in the OFF-chain state becomes the ON-chain state.

In the control unit 33, the processing from generation of the withdrawal request to transmission of the transaction to the withdrawal contract is executed as processing for withdrawing the NFT designated by the user. In particular, this processing can be said to be processing of correlating the NFT in the OFF-chain state designated by the user among the listed NFTs with the wallet (non-custodial wallet) designated by the user to set the NFT to an ON-chain state.

Note that correlating the NFT with the wallet and setting the NFT to the ON-chain state means correlating the wallet with the NFT by recording a transaction including the address information of the wallet as the owner information in the blockchain.

When the NFT (transaction) is recorded in the blockchain, the withdrawal request processing by the user terminal 21 and the response processing by the external service server 22 end.

As described above, the user terminal 21 withdraws the OFF-chain NFT selected in the custodial wallet to the non-custodial wallet. For example, in the user terminal 21, the withdrawal can be easily performed by designating an NFT listed in the custodial wallet, which improves convenience.

In addition, in the user terminal 21, since a plurality of wallets including a custodial wallet and a non-custodial wallet are correlated with each other, it is possible to easily transfer the crypto asset from any wallet to another wallet.

For example, it is assumed that the user operates the input unit 32 in a state where the screen of FIG. 3, FIG. 6, or the like is displayed on the display unit 31 of the user terminal 21, and designates (inputs) address information of a transmission source wallet, address information of a transmission destination wallet, a crypto asset to be transferred, and a transfer amount.

In such a case, the control unit 33 executes processing for transferring an asset (crypto asset) owned in a wallet of the user to another wallet of the user based on the address information of the wallet while communicating with the custodial server 23 and an external device via the communication unit 34 as necessary. That is, the control unit 33 issues a transaction for transfer, transmits the issued transaction to a smart contract or the like, and records the transaction in the blockchain.

At this time, for example, the address information of the wallet of the transmission source (transfer source) designated by the user, the address information of the wallet of the transmission destination (transfer destination), and information indicating a transfer amount of the crypto asset are stored in the transaction. That is, a transaction for transferring the designated amount of crypto asset from the transmission source wallet to the transmission destination wallet designated by the user is generated. Here, the transmission source wallet and the transmission destination wallet may be a custodial wallet or a non-custodial wallet.

### Configuration Example of Computer

Incidentally, the above-described series of processing can be executed by hardware or software. In a case where the series of processing is executed by software, a program that constitutes the software is installed on a computer.

Here, the computer includes a computer incorporated in dedicated hardware and a general-purpose personal computer capable of executing various functions by installing various programs, for example.

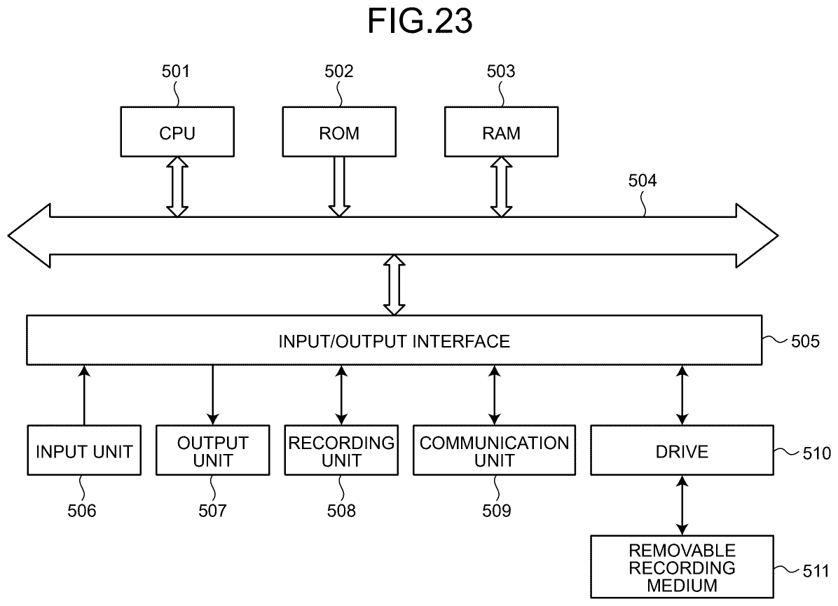

FIG. 23 is a block diagram illustrating an example of the hardware configuration of a computer that executes the above-described series of processing using a program.

In the computer, a central processing unit (CPU) 501, a read only memory (ROM) 502, and a random access memory (RAM) 503 are mutually connected by a bus 504.

An input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, and an imaging device. The output unit 507 includes a display and a speaker. The recording unit 508 includes a hard disk and a nonvolatile memory. The communication unit 509 includes a network interface. The drive 510 drives a removable recording medium 511 such as a magnetic disk, an optical disk, a magneto-optical disk, or a semiconductor memory.

In the computer configured as described above, for example, the CPU 501 loads a program recorded in the recording unit 508 into the RAM 503 via the input/output interface 505 and the bus 504 and executes the program, whereby the above-described series of processing is performed.

The program executed by the computer (CPU501) can be provided by being recorded in the removable recording medium 511 as a package medium or the like, for example. Further, the program can be provided via a wired or wireless transmission medium such as a local area network, the Internet, or digital satellite broadcasting.

In the computer, the program can be installed in the recording unit 508 via the input/output interface 505 by attaching the removable recording medium 511 to the drive 510. Further, the program can be received by the communication unit 509 via a wired or wireless transmission medium and installed in the recording unit 508. In addition, the program can be installed in the ROM 502 or the recording unit 508 in advance.

The program executed by the computer may be a program in which processing is performed in time series in the order described in the present specification, or may be a program in which processing is performed in parallel or at necessary timing such as when called.

Further, the embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Further, each step described in the above-described flowcharts can be executed by one device or can be shared and executed by a plurality of devices.

Further, in a case where a plurality of processes is included in one step, the plurality of processes included in that one step can be executed by one device or can be shared and executed by a plurality of devices.

Furthermore, the present technology can have the following configurations.
(1) An information processing device comprising:
   a recording unit that records address information of a plurality of wallets of a user including a custodial wallet and a non-custodial wallet in correlation with each other; and
   a control unit that switches, based on the address information, the wallet to be used among the plurality of wallets according to an operation by the user.
(2) The information processing device according to (1), further comprising
   a display unit that displays a screen related to an application that uses the wallet, wherein
   the control unit switches the wallet according to an operation on the screen by the user.
(3) The information processing device according to (2), wherein
   the display unit displays a list of the plurality of wallets on the screen, and
   the control unit switches the wallet to be used to the wallet selected from the list by the user.
(4) The information processing device according to (2), wherein
   the display unit displays the screen in a mode in which the wallet selected is used, and
   the control unit switches the mode and the wallet according to a swipe operation on the screen.
(5) The information processing device according to any one of (1) to (4), further comprising
   a communication unit that acquires, from a server managing a private key of the custodial wallet, NFT information related to an NFT held in an account related to each of the plurality of wallets of the user, wherein
   the control unit displays, based on the NFT information, a list of the NFTs in at least one of an OFF-chain state and an ON-chain state held in each of the plurality of accounts of the user on a screen in a mode in which the custodial wallet is used.
(6) The information processing device according to (5), wherein
   the control unit executes, based on the NFT information, processing of correlating the NFT in an OFF-chain state designated by the user among the NFTs listed with the wallet designated by the user to set the NFT in an ON-chain state.
(7) The information processing device according to any one of (1) to (6), wherein
   the control unit executes, based on the address information, processing of transferring an asset held in the wallet of the user to another wallet of the user.
(8) The information processing device according to any one of (1) to (7), further comprising
   a communication unit that acquires, from a server managing a private key of the custodial wallet, user information used for identity verification of the user at time of opening an account related to the custodial wallet, wherein
   the control unit uses the user information as information regarding the user when using a predetermined service in a mode in which the non-custodial wallet is used.
(9) An information processing method comprising:
   switching, by an information processing device,
   based on address information of a plurality of wallets of a user including a custodial wallet and a non-custodial wallet recorded in correlation with each other in a recording unit, the wallet to be used among the plurality of wallets according to an operation by the user.
(10) A program that causes a computer to execute processing comprising a step of
   switching, based on address information of a plurality of wallets of a user including a custodial wallet and a non-custodial wallet recorded in correlation with each other in a recording unit, the wallet to be used among the plurality of wallets according to an operation by the user.
(11) An information processing device for managing a private key of a custodial wallet of a user,
   the information processing device comprising:
   a recording unit that records account information related to the custodial wallet of the user and address information of a non-custodial wallet of the user in correlation with each other;
   a communication unit that acquires NFT information related to an NFT held in an account related to the non-custodial wallet of the user; and
   an NFT information management unit that records, in the recording unit, the NFT information acquired, the address information of the non-custodial wallet, and the account information related to the custodial wallet of the user in the recording unit in correlation with each other, wherein
   the communication unit transmits the NFT information recorded to a user terminal of the user.
(12) The information processing device according to (11), wherein
   the communication unit acquires, based on the address information of the non-custodial wallet, the NFT information by reading data including the address information and the NFT information from a P2P database.
(13) The information processing device according to (11), wherein
   the communication unit acquires the NFT information by receiving the NFT information, the account information related to the custodial wallet, and the address information of the non-custodial wallet transmitted from the user terminal.
(14) The information processing device according to any one of (11) to (13), wherein
   the communication unit acquires, from the user terminal, access token information for accessing a server that manages the NFT held in the account related to the non-custodial wallet of the user, and acquires, from the server, the NFT information based on the access token information.
(15) The information processing device according to any one of (11) to (13), wherein
   the communication unit acquires the NFT information by receiving the NFT information transmitted from a server that manages the NFT held in the account related to the non-custodial wallet of the user based on the address information of the non-custodial wallet registered by the user terminal in the server.
(16) The information processing device according to any one of (11) to (15), wherein
   the communication unit acquires the NFT information for the NFT in at least one of an OFF-chain state and an ON-chain state.
(17) An information processing method comprising:
   by an information processing device managing a private key of a custodial wallet of a user and including a recording unit that records account information related to the custodial wallet of the user and address information of a non-custodial wallet of the user in correlation with each other,
   acquiring NFT information related to an NFT held in an account related to the non-custodial wallet of the user;
   recording, in the recording unit, the NFT information acquired, the address information of the non-custodial wallet, and the account information related to the custodial wallet of the user in correlation with each other; and
   transmitting the NFT information recorded in the recording unit to a user terminal of the user.
(18) A program that causes a computer to execute processing, the computer controlling an information processing device managing a private key of a custodial wallet of a user and including a recording unit that records account information related to the custodial wallet of the user and address information of a non-custodial wallet of the user in correlation with each other, the processing comprising steps of:
   acquiring NFT information related to an NFT held in an account related to the non-custodial wallet of the user;
   recording, in the recording unit, the NFT information acquired, the address information of the non-custodial wallet, and the account information related to the custodial wallet of the user in correlation with each other; and
   transmitting the NFT information recorded in the recording unit to a user terminal of the user.
(19) An information processing system comprising
   a server for managing a private key of a custodial wallet of a user and a user terminal of the user, wherein
   the server includes:
   a recording unit that records account information related to the custodial wallet of the user and address information of a non-custodial wallet of the user in correlation with each other,
   a first communication unit that acquires NFT information related to an NFT held in an account related to the non-custodial wallet of the user, and
   an NFT information management unit that records, in the recording unit, the NFT information acquired, the address information of the non-custodial wallet, and the account information related to the custodial wallet of the user in correlation with each other,
   the first communication unit transmits the NFT information recorded in the recording unit to the user terminal, and
   the user terminal includes
   a second communication unit that receives the NFT information transmitted from the server, and
   a control unit that displays, based on the NFT information, a list of the NFTs in at least one of an OFF-chain state and an ON-chain state held in each of the plurality of accounts of the user on a screen in a mode in which the custodial wallet is used.

### Reference Signs List

11 INFORMATION PROCESSING SYSTEM
21 USER TERMINAL
22 EXTERNAL SERVICE SERVER
23 CUSTODIAL SERVER
31 DISPLAY UNIT
33 CONTROL UNIT
34 COMMUNICATION UNIT
35 RECORDING UNIT
43 ADDRESS MANAGEMENT UNIT
44 NFT INFORMATION MANAGEMENT UNIT
61 CONTROL UNIT
62 COMMUNICATION UNIT
63 RECORDING UNIT
64 OFF-CHAIN NFT MANAGEMENT UNIT
91 CONTROL UNIT
92 COMMUNICATION UNIT
93 RECORDING UNIT
103 ADDRESS MANAGEMENT UNIT
104 USER INFORMATION MANAGEMENT UNIT
105 EXTERNAL SERVICE ACCOUNT MANAGEMENT UNIT
106 NFT INFORMATION MANAGEMENT UNIT

1. An information processing device comprising:
a recording unit that records address information of a plurality of wallets of a user including a custodial wallet and a non-custodial wallet in correlation with each other; and
a control unit that switches, based on the address information, the wallet to be used among the plurality of wallets according to an operation by the user.

2. The information processing device according to claim 1, further comprising
a display unit that displays a screen related to an application that uses the wallet, wherein
the control unit switches the wallet according to an operation on the screen by the user.

3. The information processing device according to claim 2, wherein
the display unit displays a list of the plurality of wallets on the screen, and
the control unit switches the wallet to be used to the wallet selected from the list by the user.

4. The information processing device according to claim 2, wherein
the display unit displays the screen in a mode in which the wallet selected is used, and
the control unit switches the mode and the wallet according to a swipe operation on the screen.

5. The information processing device according to claim 1, further comprising
a communication unit that acquires, from a server managing a private key of the custodial wallet, NFT information related to an NFT held in an account related to each of the plurality of wallets of the user, wherein
the control unit displays, based on the NFT information, a list of the NFTs in at least one of an OFF-chain state and an ON-chain state held in each of the plurality of accounts of the user on a screen in a mode in which the custodial wallet is used.

6. The information processing device according to claim 5, wherein
the control unit executes, based on the NFT information, processing of correlating the NFT in an OFF-chain state designated by the user among the NFTs listed with the wallet designated by the user to set the NFT in an ON-chain state.

7. The information processing device according to claim 1, wherein
the control unit executes, based on the address information, processing of transferring an asset held in the wallet of the user to another wallet of the user.

8. The information processing device according to claim 1, further comprising
a communication unit that acquires, from a server managing a private key of the custodial wallet, user information used for identity verification of the user at time of opening an account related to the custodial wallet, wherein
the control unit uses the user information as information regarding the user when using a predetermined service in a mode in which the non-custodial wallet is used.

9. An information processing method comprising:
switching, by an information processing device,
based on address information of a plurality of wallets of a user including a custodial wallet and a non-custodial wallet recorded in correlation with each other in a recording unit, the wallet to be used among the plurality of wallets according to an operation by the user.

10. A program that causes a computer to execute processing comprising a step of
switching, based on address information of a plurality of wallets of a user including a custodial wallet and a non-custodial wallet recorded in correlation with each other in a recording unit, the wallet to be used among the plurality of wallets according to an operation by the user.

11. An information processing device for managing a private key of a custodial wallet of a user,
the information processing device comprising:
a recording unit that records account information related to the custodial wallet of the user and address information of a non-custodial wallet of the user in correlation with each other;
a communication unit that acquires NFT information related to an NFT held in an account related to the non-custodial wallet of the user; and
an NFT information management unit that records, in the recording unit, the NFT information acquired, the address information of the non-custodial wallet, and the account information related to the custodial wallet of the user in the recording unit in correlation with each other, wherein
the communication unit transmits the NFT information recorded to a user terminal of the user.

12. The information processing device according to claim 11, wherein
the communication unit acquires, based on the address information of the non-custodial wallet, the NFT information by reading data including the address information and the NFT information from a P2P database.

13. The information processing device according to claim 11, wherein
the communication unit acquires the NFT information by receiving the NFT information, the account information related to the custodial wallet, and the address information of the non-custodial wallet transmitted from the user terminal.

14. The information processing device according to claim 11, wherein
the communication unit acquires, from the user terminal, access token information for accessing a server that manages the NFT held in the account related to the non-custodial wallet of the user, and acquires, from the server, the NFT information based on the access token information.

15. The information processing device according to claim 11, wherein
the communication unit acquires the NFT information by receiving the NFT information transmitted from a server that manages the NFT held in the account related to the non-custodial wallet of the user based on the address information of the non-custodial wallet registered by the user terminal in the server.

16. The information processing device according to claim 11, wherein
the communication unit acquires the NFT information for the NFT in at least one of an OFF-chain state and an ON-chain state.

17. An information processing method comprising:
by an information processing device managing a private key of a custodial wallet of a user and including a recording unit that records account information related to the custodial wallet of the user and address information of a non-custodial wallet of the user in correlation with each other,
acquiring NFT information related to an NFT held in an account related to the non-custodial wallet of the user;
recording, in the recording unit, the NFT information acquired, the address information of the non-custodial wallet, and the account information related to the custodial wallet of the user in correlation with each other; and
transmitting the NFT information recorded in the recording unit to a user terminal of the user.

18. A program that causes a computer to execute processing, the computer controlling an information processing device managing a private key of a custodial wallet of a user and including a recording unit that records account information related to the custodial wallet of the user and address information of a non-custodial wallet of the user in correlation with each other, the processing comprising steps of:
acquiring NFT information related to an NFT held in an account related to the non-custodial wallet of the user;
recording, in the recording unit, the NFT information acquired, the address information of the non-custodial wallet, and the account information related to the custodial wallet of the user in correlation with each other; and
transmitting the NFT information recorded in the recording unit to a user terminal of the user.

19. An information processing system comprising
a server for managing a private key of a custodial wallet of a user and a user terminal of the user, wherein
the server includes:
a recording unit that records account information related to the custodial wallet of the user and address information of a non-custodial wallet of the user in correlation with each other,
a first communication unit that acquires NFT information related to an NFT held in an account related to the non-custodial wallet of the user, and
an NFT information management unit that records, in the recording unit, the NFT information acquired, the address information of the non-custodial wallet, and the account information related to the custodial wallet of the user in correlation with each other,
the first communication unit transmits the NFT information recorded in the recording unit to the user terminal, and
the user terminal includes
a second communication unit that receives the NFT information transmitted from the server, and
a control unit that displays, based on the NFT information, a list of the NFTs in at least one of an OFF-chain state and an ON-chain state held in each of the plurality of accounts of the user on a screen in a mode in which the custodial wallet is used.
